(19) United States
(12) Patent Application Publication
(10) Pub. No.: US 2026/0212185 A1
(43) Pub. Date: Jul. 23, 2026

(54) Geometrically-Grounded Persistent Cognitive Architecture with Invariant-Enforced Federated Intelligence

(71) Applicant: AtomBeam Technologies Inc., Moraga, CA (US)

(72) Inventor: Brian Galvin, Silverdale, WA (US)

(21) Appl. No.: 19/567,692

(22) Filed: Mar. 16, 2026

Related U.S. Application Data
(63) Continuation-in-part of application No. 19/550,709, filed on Feb. 26, 2026.
Application No. 19/550,709 is a continuation-in-part of application No. 19/548,024, filed on Feb. 24, 2026.
Application No. 19/548,024 is a continuation-in-part of application No. 19/546,407, filed on Feb. 22, 2026.
Application No. 19/546,407 is a continuation-in-part of application No. 19/534,677, filed on Feb. 9, 2026.
(63) Continuation-in-part of application No. 19/294,125, filed on Aug. 7, 2025, now Pat. No. 12,579,437.
Application No. 19/294,125 is a continuation-in-part of application No. 19/203,069, filed on Jun. 3, 2025, now Pat. No. 12,481,688.
Application No. 19/203,069 is a continuation of application No. 19/205,960, filed on May 12, 2025.
Application No. 19/205,960 is a continuation-in-part of application No. 19/060,794, filed on Feb. 24, 2025.
Application No. 19/060,794 is a continuation-in-part of application No. 19/044,546, filed on Feb. 3, 2025.
Application No. 19/044,546 is a continuation-in-part of application No. 19/026,276, filed on Jan. 16, 2025.
Application No. 19/026,276 is a continuation-in-part of application No. 18/928,022, filed on Oct. 26, 2024.
Application No. 18/928,022 is a continuation-in-part of application No. 18/919,417, filed on Oct. 17, 2024, now Pat. No. 12,602,586.
Application No. 18/919,417 is a continuation-in-part of application No. 18/918,077, filed on Oct. 17, 2024.
Application No. 18/918,077 is a continuation-in-part of application No. 18/737,906, filed on Jun. 7, 2024.
Application No. 18/737,906 is a continuation-in-part of application No. 18/736,498, filed on Jun. 6, 2024.
Application No. 19/294,125 is a continuation-in-part of application No. 19/178,873, filed on Apr. 15, 2025, now Pat. No. 12,608,631.
Application No. 19/178,873 is a continuation-in-part of application No. 19/177,611, filed on Apr. 13, 2025, now Pat. No. 12,572,471.
Application No. 19/177,611 is a continuation-in-part of application No. 19/051,193, filed on Feb. 12, 2025, now Pat. No. 12,387,050.
(60) Provisional application No. 63/651,359, filed on May 23, 2024.
(60) Provisional application No. 63/965,251, filed on Jan. 21, 2026.
(60) Provisional application No. 63/965,273, filed on Jan. 21, 2026.
(60) Provisional application No. 63/965,321, filed on Jan. 21, 2026.
(60) Provisional application No. 63/966,904, filed on Jan. 23, 2026.
(60) Provisional application No. 63/966,944, filed on Jan. 23, 2026.
(60) Provisional application No. 63/966,955, filed on Jan. 23, 2026.
(60) Provisional application No. 63/967,705, filed on Jan. 25, 2026.
(60) Provisional application No. 63/967,707, filed on Jan. 25, 2026.
(60) Provisional application No. 63/967,710, filed on Jan. 25, 2026.
(60) Provisional application No. 63/967,713, filed on Jan. 25, 2026.
(60) Provisional application No. 63/967,715, filed on Jan. 25, 2026.
(60) Provisional application No. 63/967,718, filed on Jan. 25, 2026.
(60) Provisional application No. 63/967,721, filed on Jan. 25, 2026.
(60) Provisional application No. 63/967,726, filed on Jan. 25, 2026.
(60) Provisional application No. 63/968,152, filed on Jan. 26, 2026.
(60) Provisional application No. 63/968,157, filed on Jan. 26, 2026.
(60) Provisional application No. 63/975,311, filed on Feb. 3, 2026.
(60) Provisional application No. 63/975,314, filed on Feb. 3, 2026.
(60) Provisional application No. 63/976,098, filed on Feb. 4, 2026.
(60) Provisional application No. 63/976,101, filed on Feb. 4, 2026.
(60) Provisional application No. 63/976,103, filed on Feb. 4, 2026.
(60) Provisional application No. 63/976,109, filed on Feb. 4, 2026.
(60) Provisional application No. 63/976,115, filed on Feb. 4, 2026.
(60) Provisional application No. 63/978,340, filed on Feb. 9, 2026.
(60) Provisional application No. 63/978,983, filed on Feb. 9, 2026.
(60) Provisional application No. 63/978,991, filed on Feb. 9, 2026.
(60) Provisional application No. 63/978,997, filed on Feb. 9, 2026.
(60) Provisional application No. 63/985,880, filed on Feb. 18, 2026.

(51) Int. Cl. G06N 3/082

(52) U.S. Cl. CPC G06N 3/082

(57) ABSTRACT

A system and method for geometrically-grounded persistent cognitive architecture with invariant-enforced federated intelligence. The system implements a persistent cognitive substrate organized as an internal configuration space supporting path-dependent traversal, within which a federated multi-tier thought caching hierarchy operates as holonomy-based constraint memory achieving sublinear complexity growth. User prompts are processed through a dual-model architecture comprising a first reasoning large language model generating thoughts and a second smaller model generating responses, with thoughts cached across local device, domain-specific branch, and global collective tiers through successive stages of non-invertible holonomy compression. A federated cognitive orchestrator implements sectorized interface management coordinating domain-specialized instances across non-commuting operational projection boundaries. The system further implements variational stabilization of reasoning trajectories, multi-domain conflict arbitration through geometric consensus, cognitive regime monitoring with adaptive resource allocation, and hallucination suppression through geometric structural validation including traversal cost, homotopy class, and holonomy consistency validation.

### CROSS-REFERENCE TO RELATED APPLICATIONS

Priority is claimed in the application data sheet to the following patents or patent applications, each of which is expressly incorporated herein by reference in its entirety:
Ser. No. 19/550,709
Ser. No. 19/548,024
Ser. No. 19/546,407
Ser. No. 19/534,677
63/985,880
63/978,340
63/978,983
63/978,991
63/978,997
63/976,098
63/976,101
63/976,103
63/976,109
63/976,115
63/975,311
63/975,314
63/968,152
63/968,157
63/967,705
63/967,707
63/967,710
63/967,713
63/967,715
63/967,718
63/967,721
63/967,726
63/966,904
63/966,944
63/966,955
63/965,251
63/965,273
63/965,321
Ser. No. 19/294,125
Ser. No. 19/203,069
Ser. No. 19/205,960
Ser. No. 19/060,794
Ser. No. 19/044,546
Ser. No. 19/026,276
Ser. No. 18/928,022
Ser. No. 18/919,417
Ser. No. 18/918,077
Ser. No. 18/737,906
Ser. No. 18/736,498
63/651,359
Ser. No. 19/178,873
Ser. No. 19/177,611
Ser. No. 19/051,193

### BACKGROUND OF THE INVENTION

### Field of the Art

The present invention relates to systems and methods for persistent cognitive computing, and more specifically to architectures that implement geometrically-grounded structural invariants within federated multi-model language processing systems to achieve continuous learning, cross-domain generalization, and scalable deployment under finite resource constraints.

### Discussion of the State of the Art

Large language models (LLMs) have achieved remarkable performance across diverse natural language processing tasks. However, fundamental architectural limitations prevent current systems from achieving true persistent intelligence—the ability to learn continuously from interaction, maintain coherent reasoning across sessions, and scale without catastrophic degradation.

Current LLM architectures represent knowledge as distributed correlations across large parameter spaces. This representation forces a fundamental tradeoff: continuous learning requires either unbounded parameter growth or interference with previously stored knowledge (catastrophic forgetting). Energy cost grows exponentially while capability grows only logarithmically with cumulative effort—a scaling relationship that is structural, not implementational.

Multi-agent and agentic AI architectures have been proposed to address some limitations of monolithic models. However, coordination cost between agents grows superlinearly with agent count, frequently scaling quadratically in practice. New knowledge must be propagated, reconciled, or re-negotiated across agents. At scale, coordination overhead overwhelms cognitive capacity.

Retrieval-augmented generation (RAG) systems attempt to provide persistence through external memory stores, but treat memory as a lookup operation rather than as structural deformation of the reasoning space. Vector databases store embeddings as isolated points without capturing the path-dependent, compositional structure that characterizes genuine learning.

What is needed is a cognitive architecture grounded in the structural invariants that any system achieving persistent intelligence must satisfy—an architecture where the specific mechanisms of thought caching, domain orchestration, autonomous reasoning, and conflict resolution are derived from geometric necessity rather than imposed by engineering convention.

### SUMMARY OF THE INVENTION

Accordingly, the inventor has conceived and reduced to practice a system and method for geometrically-grounded persistent cognitive architecture with invariant-enforced federated intelligence. The system implements a persistent cognitive substrate organized as an internal configuration space supporting path-dependent traversal, within which a federated multi-tier thought caching hierarchy operates as holonomy-based constraint memory achieving sublinear complexity growth. User prompts are processed through a dual-model architecture comprising a first reasoning large language model generating thoughts and a second smaller model generating responses, with thoughts cached across local device, domain-specific branch, and global collective tiers through successive stages of non-invertible holonomy compression. A federated cognitive orchestrator implements sectorized interface management coordinating domain-specialized instances across non-commuting operational projection boundaries. The system further implements variational stabilization of reasoning trajectories, multi-domain conflict arbitration through geometric consensus, cognitive regime monitoring with adaptive resource allocation, and hallucination suppression through geometric structural validation including traversal cost, homotopy class, and holonomy consistency validation.

According to a preferred embodiment, a computer system comprising a hardware memory, wherein the computer system is configured to execute software instructions stored on nontransitory machine-readable storage media that implement a persistent cognitive substrate organized as an internal configuration space supporting path-dependent traversal, wherein the system: receives a prompt from a user; projects the prompt into the persistent cognitive substrate through an operational projection that maps input into the internal configuration space where cognitive compatibility corresponds to geometric proximity; processes the prompt into a plurality of corresponding thoughts using a first reasoning large language model, wherein each thought corresponds to a structured region within the persistent cognitive substrate; routes both the prompt and the plurality of thoughts through a second large language model that has fewer parameters than the first reasoning large language model; associates each corresponding thought in the plurality of corresponding thoughts to a portion of the prompt through geometric correspondence within the persistent cognitive substrate; caches each associated corresponding thought in a federated multi-tier thought caching hierarchy operating as a holonomy-based constraint memory, the hierarchy comprising at least a local device cache, a domain-specific branch instance cache, and a global collective cache, wherein repeated or compatible thoughts are compressed into shared geometric structure such that representational complexity grows sublinearly with accumulated experience; generates a response to the prompt by processing the plurality of thoughts and the prompt through the second large language model; continues autonomous reasoning operations without user interaction in a cloud environment, generating new thoughts based on existing cached thoughts and user interaction history through background reorganization of the persistent cognitive substrate; and coordinates federated cognitive operations across multiple domain-specialized instances through a federated cognitive orchestrator implementing sectorized interface management, wherein domain boundaries correspond to regions of the persistent cognitive substrate where operational projections are non-commuting, and wherein the orchestrator manages thought routing, state synchronization, and cross-domain knowledge sharing while maintaining domain boundaries through graduated access controls.

In an aspect of an embodiment, the system implements variational stabilization of reasoning trajectories, wherein an action functional over trajectory space within the persistent cognitive substrate is deformed by experience such that successful reasoning patterns are reinforced through reduced traversal cost and unsuccessful reasoning patterns are suppressed through increased curvature resistance.

In an aspect of an embodiment, the system implements non-invertible residual export, wherein irreconcilable semantic conflicts arising from cross-domain reasoning operations are projected into a residual sector of the persistent cognitive substrate from which they cannot be reconstructed, ensuring monotonic constraint accumulation and preventing oscillatory reasoning failures.

In an aspect of an embodiment, promoting a thought from a lower tier to a higher tier of the federated multi-tier thought caching hierarchy comprises non-invertible compression of the thought through successive stages of holonomy compression, wherein path-specific details are compressed into transport equivalence classes at each stage and information specific to the originating scope is irreversibly removed.

In an aspect of an embodiment, wherein the system implements multi-domain conflict arbitration comprising: detecting divergent response trajectories across multiple domain-specialized instances by evaluating geometric distance between response trajectories within the persistent cognitive substrate; evaluating structural support for each conflicting response based on domain-specific curvature, holonomy weight, and homotopy stability; determining whether a geometric consensus trajectory exists that is reachable from each conflicting trajectory through admissible deformation; and exporting resolved conflicts into a residual sector through non-invertible projection.

In an aspect of an embodiment, wherein the system implements cognitive regime monitoring based on a cognitive saturation ratio measuring the relationship between mismatch intensity and adaptive capacity, and wherein the system adaptively adjusts processing depth, model selection, and resource allocation in response to transitions between cognitive regimes.

In an aspect of an embodiment, the cognitive regime monitoring detects at least four operational regimes: a weak saturation regime with cache-dominated processing, a selective saturation regime with narrowed trajectory admissibility, a localized saturation regime with explicit uncertainty signaling and deferred judgment, and a distributed near-saturation regime with activated background reorganization.

In an aspect of an embodiment, the system implements hallucination suppression through geometric structural validation comprising: traversal cost validation that flags response trajectories requiring traversal through high-cost regions of the persistent cognitive substrate; homotopy class validation that flags response trajectories not belonging to established homotopy classes; and holonomy consistency validation that flags response trajectories whose loop holonomy is inconsistent with accumulated holonomy in relevant cache tiers.

In an aspect of an embodiment, the system implements battery-aware geometric processing that dynamically adjusts depth and scope of persistent cognitive substrate operations based on device power state, including multiple execution profiles ranging from full-depth traversal with background reorganization to local-cache-only operation with essential state preservation.

In an aspect of an embodiment, the system implements bandwidth-adaptive federated synchronization that adjusts granularity and frequency of structural exchange between federated instances based on available network bandwidth, wherein the system exchanges compressed geometric structure at a synchronization cost that scales as O(1) relative to accumulated experience.

In an aspect of an embodiment, the system implements privacy-preserving structural exchange comprising: multi-stage anonymization of thought patterns through progressive removal of personally identifiable information while preserving geometric structure including trajectory class, holonomy signature, and homotopy membership; and contrastive validation ensuring anonymized patterns retain cognitive utility while preventing re-identification through completed non-invertible projection into a residual sector.

In an aspect of an embodiment, the persistent cognitive substrate implements background reorganization during periods of user inactivity coordinated by a hierarchical sleep management system, the background reorganization comprising perturbation and recombination of existing substrate structure, merging of compatible structures into higher-level abstractions through holonomy compression, and pruning of unused structure through residual export.

In an aspect of an embodiment, the persistent cognitive substrate implements a lifecycle of cognition comprising: encounter and projection of input into the substrate; traversal and use along paths shaped by prior learning; constraint accumulation manifesting as geometric strain at domain boundaries; consolidation through reuse that compresses and stabilizes substrate regions; and background reorganization that smooths irregularities and merges compatible structures.

In an aspect of an embodiment, the system implements scaling without resource explosion across memory, computation, and coordination dimensions, wherein effective memory grows sublinearly with accumulated experience through holonomy-based compression, marginal computational cost decreases over time through variational stabilization of frequently used reasoning trajectories, and coordination cost is absorbed into persistent cognitive substrate structure rather than expressed as inter-agent communication.

In an aspect of an embodiment, the federated cognitive orchestrator evaluates a mismatch functional at sector boundaries quantifying the degree of incompatibility between domain representations, and wherein the orchestrator routes cross-domain knowledge transfers through the cross-domain integration framework when mismatch is below an absorption threshold and exports excess mismatch into a residual sector when mismatch exceeds the absorption threshold.

### BRIEF DESCRIPTION OF THE DRAWING FIGURES

FIG. 1 is a block diagram illustrating an exemplary system architecture of an epistemically conditioned persistent cognitive machine comprising interconnected subsystems arranged in a gated pipeline enforcing structural hallucination suppression.

FIG. 2 is a block diagram illustrating an epistemically conditioned manifold substrate maintaining a semantic metric, an almost-complex structure, a symplectic form, and an epistemic connection together implementing capacity constraints, admissibility boundaries, degeneracy regions, and structural gradients.

FIG. 3 is a block diagram illustrating a consolidation and irreversible suppression subsystem implementing reservoir formation, constraint projection, revision control, and asymmetric feedback mechanisms.

FIG. 4 is a flow diagram illustrating an exemplary epistemic admission control process performing structural compatibility evaluation, capacity-based admission, topological admissibility assessment, and epistemic curvature screening.

FIG. 5 is a flow diagram illustrating holonomy and epistemic phase monitoring during reasoning traversal, including phase accumulation, discontinuity detection, loop regime classification, and corroboration evaluation.

FIG. 6 is a flow diagram illustrating consolidation and irreversible suppression processes including reservoir readiness evaluation, consolidation gating across layers, non-invertible constraint projection, and localized revision.

FIG. 7 is a flow diagram illustrating coordinated operation of three structural hallucination suppression layers operating before, during, and after reasoning execution with cross-layer feedback interactions.

FIG. 8 is a flow diagram illustrating output generation and expression control conditioned on epistemic admissibility, including decoding, qualification, and suppression outcomes.

FIG. 9 is a flow diagram illustrating end-to-end data flow through the persistent cognitive system from input projection through admission, traversal, consolidation or suppression, output generation, and asynchronous geometric evolution.

FIG. 10 is a block diagram illustrating an exemplary architecture of a dual large language model processing pipeline and federated multi-tier thought caching hierarchy operating within a persistent cognitive system, according to an embodiment.

FIG. 11 is a block diagram illustrating an exemplary architecture of a federated cognitive orchestrator and multi-domain conflict arbitration subsystem within a federated cognitive system, according to an embodiment.

FIG. 12 is a block diagram illustrating an exemplary architecture of a cognitive regime monitoring system, variational stabilization engine, hallucination suppression validator, and resource adaptation manager integrated within an adaptive cognitive monitoring system, according to an embodiment.

FIG. 13 illustrates an exemplary computing environment on which an embodiment described herein may be implemented.

### DETAILED DESCRIPTION OF THE INVENTION

The inventor has conceived and reduced to practice a system and method for geometrically-grounded persistent cognitive architecture with invariant-enforced federated intelligence.

The present system is compatible with and extends any Persistent Cognitive Machine (PCM) architecture in which cognition is represented as structured traversal through a latent manifold that persists across interactions. Where a prior PCM architecture maintains holonomy descriptors encoding path-dependent experiential effects and manages homotopy class reasoning for suppression of inadmissible loop structures, the present system leverages those holonomy descriptors as instruments of epistemic monitoring and extends homotopy class management to handle epistemically conditioned constraint artifacts incorporating geometric information including curvature regime, capacity violation type, and phase drift signature in addition to homotopy class constraint patterns. Where a prior PCM architecture maintains irreversible reservoirs storing non-reconstructable constraint artifacts derived from inadmissible homotopy classes and propagates constraint patterns for read-only queries during class identification, the present system extends the reservoir infrastructure to additionally manage geometric reservoirs constituting consolidated knowledge as regions of the epistemically conditioned manifold satisfying phase flatness, barrier energy, and admission control conditions. The prior reservoir system handles information the system has learned to avoid; the geometric reservoirs of the present architecture additionally handle information the system has durably committed to. Both types of reservoir are irreversible in that projected constraint patterns cannot be reconstructed and consolidated geometric reservoirs resist perturbation with quantifiable stability bounds. The present system may be implemented incrementally by augmenting an existing PCM architecture with the epistemic conditioning structures and the three-layer hallucination suppression mechanisms disclosed herein, or may be implemented as a unified architecture incorporating all disclosed subsystems.

A computer system comprises one or more processors and non-transitory machine-readable storage media storing instructions that maintain a latent manifold serving as a cognitive substrate. The latent manifold represents cognitive states as locations and reasoning processes as trajectories through a geometric space. A semantic metric g defined on the manifold encodes semantic dissimilarity between cognitive states and determines geodesic distances and curvature. An almost-complex structure J defined on tangent spaces satisfies J squared equals negative identity and constrains admissible deformations of the manifold. A symplectic form ω is reconstructed from the semantic metric and the almost-complex structure according to a compatibility relation, for example ω(X, Y) =g(JX, Y), and satisfies dω=0. An epistemic line bundle L over the manifold is equipped with a U(1) connection A whose curvature F equals dA. The collection (g, J, ω, A) defines an epistemically conditioned manifold.

A semantic metric encodes semantic proximity between cognitive states. In some embodiments, further geometric structures are employed to encode evidential consistency and admissibility constraints in addition to semantic distance. A Riemannian manifold with metric g cannot distinguish between semantically similar but epistemically opposed propositions if they occupy nearby locations under g. The metric also permits smooth deformations that preserve distances without explicitly representing evidential relationships. Further, a Riemannian metric provides path length as a scalar but does not encode whether a reasoning path preserves justificatory integrity. The addition of J, ω, and A provides additional geometric structure that represents evidential relationships and path-level coherence properties not captured by semantic metric alone.

The epistemic line bundle L assigns to each manifold location a complex fiber representing an evidential state. In an embodiment, parallel transport of a section s along a path γ satisfies ∇As=ds+As=0, yielding s(γ(1))=exp(−i [symbol] γA)s(γ(0)). The magnitude of s is preserved under transport while its phase may rotate. The curvature F=dA measures failure of parallel transport around infinitesimal loops to return identity. In an embodiment, total curvature over a closed surface Σ satisfies (½π)∫ΣF∈ [symbol] , representing a first Chern number that quantizes enclosed epistemic curvature. The epistemic connection is independent of a Levi-Civita connection derived from the semantic metric and may assign different curvature values to regions that are metrically identical.

A discrete realization of the manifold may be implemented as a simplicial complex G=(V, E, F) comprising vertices V representing cognitive states, edges E representing semantic adjacencies, and faces F representing local neighborhoods. The semantic metric is represented by edge weights gij. The almost-complex structure is represented per vertex by a linear map Ji on an approximate tangent space. The symplectic form is computed on a face f=(i, j, k) as ωf=ω(eij,eik) using ω(X, Y)=g(JX, Y). The epistemic connection assigns to each oriented edge (i, j) a phase uij=exp(iθij) with θji=−θij. A discrete curvature value on a face f is computed, for example, as Ff=θij+θjk+θki modulo 2π. A Wilson loop for a closed path γ is computed as a product of edge phases or equivalently as Φ(γ)=Σθ along γ. By a discrete Stokes relation, Φ(γ) equals a sum of Ff over faces enclosed by γ modulo 2π.

The architecture addresses two structurally distinct modes of hallucination, each requiring a dedicated suppression mechanism. A first mode, referred to herein as a regime hallucination, arises when a cognitive system attempts to consolidate or reason along a trajectory whose structural class is inadmissible within the epistemically conditioned manifold. In a regime hallucination, a trajectory as a whole violates epistemic constraints regardless of quality of individual steps. A regime hallucination may occur when a trajectory targets a forbidden region, exceeds symplectic capacity, or belongs to a homotopy class that has been projected into an irreversible reservoir. An epistemic admission control subsystem is directed primarily at suppressing regime hallucinations by evaluating structural admissibility before reasoning execution begins, thereby inhibiting instantiation of classes of trajectories that violate admissibility constraints.

A second mode, referred to herein as a drift hallucination, arises when a topologically admissible trajectory accumulates significant epistemic phase drift during traversal such that each individual step may be locally reasonable but cumulative effect is epistemic incoherence. In a drift hallucination, a trajectory passes all admission checks and does not violate any single constraint in isolation, but accumulated rotation of evidential grounding along a path renders final conclusion epistemically illegitimate. A holonomy and epistemic phase monitoring subsystem is directed primarily at suppressing drift hallucinations by tracking a path-dependent coherence quantity during traversal and detecting when cumulative phase drift exceeds a coherent regime. Distinction between regime hallucinations and drift hallucinations motivates architectural separation between pre-execution admission control and in-execution phase monitoring, because neither mechanism alone is sufficient to address both modes.

An input projection subsystem receives an external input or internally generated candidate state and maps the candidate state to a provisional location on the manifold using semantic attachment, such as harmonic extension from nearby landmark states. The provisional location is not immediately incorporated into active reasoning. An epistemic admission control subsystem evaluates admissibility of the provisional state prior to allowing formation of a reasoning trajectory. The admission control subsystem evaluates structural compatibility of an interpolated almost-complex structure by computing a residual such as rJ(p0)=max [symbol] ∥(Πp0→ [symbol] )*Jp0(Πp0→ [symbol] )−1−J [symbol] ∥. The admission control subsystem evaluates symplectic capacity by computing a local capacity cω(i)=Σ|ωf| over incident faces and a capacity density ρω(i) as vertex count divided by cω(i), denying admission if ρ*ω exceeds threshold ρω. The admission control subsystem evaluates epistemic curvature by computing insertion curvature Fmax(p0) as maximum |Ff| over new faces and by performing micro-holonomy screening on short loops γ of bounded length Lmax, verifying |Φ(γ)|≤Φ*. The admission control subsystem evaluates topological admissibility within a reservoir-stratified state space defined by removing barrier neighborhoods associated with consolidated regions.

A reservoir-stratified state space M*⋄=M*\B(R) modifies topology of accessible state space. Removing barrier neighborhoods corresponding to consolidated regions changes a fundamental group of accessible state space so that homotopy classes become content-dependent. A trajectory contractible in an unconditioned manifold may become non-contractible in a stratified space if it must circumvent a reservoir boundary. Topological admissibility therefore depends on content of consolidated knowledge.

The admission control subsystem classifies outcomes including absorption, flagging, defect, or veto. Absorption incorporates a state fully into the manifold. Flagging permits participation in reasoning but excludes consolidation until stabilization. A defect records a boundary event when a provisional state near a reservoir boundary exhibits excessive curvature or phase drift. A veto prevents insertion when capacity constraints are violated.

A traversal and reasoning subsystem computes reasoning trajectories through the manifold from admitted states. During traversal, a holonomy and epistemic phase monitoring subsystem accumulates epistemic phase Φ(γ) along a trajectory. A closed loop γ is classified into regimes based on magnitude of Φ(γ). A coherent regime satisfies |Φ(γ)|≤Φ*. A drift regime satisfies Φ*<|Φ(γ)|<π and may require corroboration by an independent path γ′ reaching same conclusion, maintaining |Φ(γ′)|≤Φ*, and not deformable into γ within a reservoir-stratified state space. An inversion regime satisfies |Φ(γ)|≥π and blocks consolidation.

The holonomy and epistemic phase monitoring subsystem detects epistemic instability not only upon explicit loop closure but also during open-path traversal before any loop closure event occurs. A phase discontinuity is a structural inconsistency detected during traversal of a cognitive trajectory indicating loss of epistemic coherence prior to completion of a closed reasoning path. Phase discontinuities may arise from abrupt shifts in abstraction level unsupported by prior experience, convergence of incompatible holonomy descriptors at a single manifold location, attempted traversal across suppressed homotopy classes, or emergence of partial loop structures exhibiting self-inconsistency. The subsystem monitors whether transported holonomy descriptors from different source paths produce contradictory phase assessments at a current traversal location. When incompatible holonomy descriptors exert contradictory influence, resulting degradation of epistemic phase coherence is treated as a hallucination precursor rather than as an ambiguous but permissible reasoning state.

When epistemic phase instability is detected, the subsystem intervenes during reasoning execution without reliance on post-hoc filtering. Intervention may comprise interruption and termination of a trajectory, redirection toward an alternative admissible path, controlled backtracking to a stable manifold location, suspension pending clarification or additional input, or marking of a trajectory for subsequent irreversible suppression. Choice among intervention mechanisms may depend on severity of detected instability, proximity to consolidated regions, and availability of alternative admissible paths.

A consolidation and irreversible suppression subsystem manages formation and stability of irreversible reservoirs. A region U of the manifold becomes a reservoir when phase flatness sup|F|≤εR holds, barrier energy E∂U exceeds threshold E*, and admission control routes compatible states into U while excluding incompatible states. Barrier energy may be computed, for example, as E∂U=∫∂U (αF|F|\hat{ }2+αK|K∂|\hat{ }2+αω|dωv|\hat{ }2) dμ. A consolidation transition is characterized as a geometric phase transition in which curvature collapses within U while boundary energy stabilizes. Consolidation exhibits hysteresis because conditions for destroying a reservoir require overcoming barrier energy and raising interior curvature above εR, which relaxation flow resists.

The consolidation and irreversible suppression subsystem classifies boundary events created by defect outcomes using phase defect magnitude and curvature decomposition into J-invariant and J-anti-invariant components. Corroborating evidence corresponds to small phase defect and curvature within threshold, resulting in absorption. Novelty corresponds to curvature predominantly compatible with J, indicating incomplete evidence and marking a growth candidate. Contradiction corresponds to curvature predominantly incompatible with J, indicating conflicting evidence and preventing extension. Ambiguous evidence corresponds to comparable curvature components and provisional attachment.

The subsystem monitors pre-reservoir regions exhibiting curvature decay under relaxation, decreasing phase variance over internal loops, increasing boundary energy, and decreasing structural compatibility residual associated with almost-complex structure. A consolidation transition occurs when interior curvature drops below flatness threshold, boundary energy exceeds barrier threshold, and boundary-aware admission control is activated. Consolidation is admitted only when topological admissibility, epistemic coherence or corroboration, and symplectic capacity constraints are concurrently satisfied.

A revision mechanism supports localized restructuring of consolidated regions when persistent contradictory boundary events accumulate beyond a revision threshold Φrev. Revision requires energy proportional to barrier energy, produces detectable boundary disturbances, and affects only region adjacent to accumulating contradiction. After restructuring, connection relaxation may restore flatness or permanently de-consolidate affected region.

A manifold evolution and execution subsystem updates geometric structures (g, J, ω, A) on separated timescales. Projection forcing operates on a fast timescale τP. A compression flow operates on an intermediate timescale τC and may minimize an extended energy including a Nijenhuis penalty term such as ∫∥NJ∥\hat{ }2 dμ. A connection relaxation flow operates on a slower timescale τR and minimizes curvature energy EA=Σf Ff\hat{ }2 through updates θij←θij−ηR ∂EA/∂θij. Timescale ordering τP<<τC<<τR reflects experience accumulation preceding geometric adjustment and geometric adjustment preceding epistemic consolidation.

Evolution may be characterized by a scaling vector S(t)=(Nsem(t), Cepi(t), Bcom(t), Sstr(t)) representing semantic complexity, epistemic curvature budget, boundary energy concentration, and structural regularity. Each component exhibits sublinear scaling, such as O(log E), with cumulative experience E. A learning readiness field Λ(b) may be defined on reservoir boundaries, for example Λ(b)=1/Egrowth(b,ε0), where Egrowth(b,ε)≈ε\hat{ }2(αω∥∇νω∥\hat{ }2+αJ∥∇νJ∥\hat{ }2+αF|F|\hat{ }2). The readiness field quantifies energetic cost of extending reservoir in direction v and channels consolidation along symplectically favored directions.

Residual vulnerability of architecture is calibrational rather than structural. A hallucination may be admitted only when a trajectory is topologically admissible, epistemically coherent or independently corroborated, capacity-consistent, and content is nevertheless unjustified due to miscalibration of epistemic connection. Miscalibration may be surfaced over time as contradictory evidence accumulates.

In an embodiment, a consolidated irreversible reservoir satisfying phase flatness and barrier energy conditions exhibits quantifiable resistance to perturbation across three complementary dimensions of stability. A first dimension is semantic stability, in which admissible deformations of the semantic metric within the reservoir that preserve almost-Kähler compatibility and respect barrier energy at the boundary produce bounded geodesic distance changes within the reservoir interior. The bound on geodesic distance perturbation is controlled by two terms: a first term proportional to a product of the flatness threshold and a squared diameter of the reservoir, reflecting that flatter epistemic curvature within the reservoir constrains metric deformations through the compatibility relation linking the semantic metric, the almost-complex structure, and the symplectic form; and a second term that decays with increasing barrier energy, reflecting that higher barrier energy attenuates the influence of exterior perturbations before they propagate into the reservoir interior. A second dimension is epistemic stability, in which any modification to the epistemic connection within the reservoir requires energy proportional to the barrier energy and produces detectable boundary defects whose magnitude is bounded below by a ratio of the modification magnitude to a square root of the reservoir volume. This detectability bound ensures that the epistemic connection within a consolidated reservoir cannot be silently altered; any attempt to undermine evidential grounding within the reservoir produces a phase signature observable by the holonomy and epistemic phase monitoring subsystem. A third dimension is structural stability, in which symplectic capacity of the reservoir is preserved under admissible evolution. Under evolution that preserves the symplectic form, symplectic capacity is exactly invariant. Under approximate evolution within the almost-Kähler compatibility class, symplectic capacity changes are bounded by the metric perturbation bound from the first dimension, ensuring that consolidated cognitive structure cannot be compressed below its intrinsic symplectic capacity. Together, the three dimensions of stability ensure that consolidated knowledge resists semantic distortion, epistemic undermining, and structural compression, with each resistance quantified by computable bounds controlled by the flatness threshold and barrier energy of the reservoir.

In an embodiment, the evidential consistency function used to assign edge phase values in the epistemic connection comprises a plurality of component functions that are combined to produce a scalar consistency value for each pair of cognitive states connected by an edge in the discrete cognitive graph. A source consistency component measures agreement between evidential provenance of a candidate cognitive state and consolidated evidence at a neighboring state, evaluating whether methods, sources, or modalities that produced the candidate state are consistent with those that established the neighbor. A cross-modal corroboration component measures whether other cortices or processing modalities independently support an association between the candidate state and the neighbor. A temporal stability component measures whether a relationship between the candidate state and the neighbor is consistent over time or fluctuating. Each component takes values in a normalized range, with a maximum value indicating full consistency and a minimum value indicating maximal inconsistency. The component values are combined, for example by summation or weighted combination, to produce a composite evidential consistency value. An edge phase is then assigned by a monotone mapping from the composite consistency value to a phase interval, such that full consistency maps to zero phase indicating trivial epistemic transport along the edge, and zero consistency maps to a maximal phase value such as π indicating maximal evidential misalignment. In one embodiment, the mapping is linear, for example θ=π(1−φ) where φ is the composite consistency value and θ is the assigned edge phase. The decomposition of the evidential consistency function into identifiable components supports diagnostic classification of epistemic strain by enabling the system to attribute curvature contributions to specific evidential deficiencies, and the monotone mapping from consistency to phase preserves ordering of consistency levels in the geometric representation.

In an embodiment, assigning an almost-complex structure at a newly projected point involves interpolation from neighboring landmark structures followed by algebraic projection onto a constraint manifold of valid almost-complex structures. An interpolated pre-structure is computed as a weighted combination of almost-complex structures at landmark neighbors, where each landmark structure is transported to the projected point via discrete parallel transport along a shortest graph path and the transported structures are combined using weights determined by the semantic attachment step. The interpolated pre-structure will not, in general, satisfy the constraint that its square equals negative identity, because a convex combination of structures each satisfying the constraint does not itself satisfy the constraint. To obtain a valid almost-complex structure, the system performs an algebraic projection of the interpolated pre-structure onto the manifold of endomorphisms satisfying the squared-equals-negative-identity constraint. In one embodiment, the projection is performed by computing a singular value decomposition of the interpolated pre-structure and replacing the singular values with a canonical block-diagonal form corresponding to the constraint, while preserving the singular subspaces. The resulting structure is the nearest valid almost-complex structure to the interpolated pre-structure in a Frobenius norm sense and satisfies the constraint by construction. The projection is well-defined and unique when the interpolated pre-structure is not equidistant from multiple elements of the constraint manifold, which is the generic case. Other algebraic projection methods that produce a valid almost-complex structure nearest to the interpolated pre-structure under a suitable norm may be used. After projection, the structural compatibility residual is computed by comparing the assigned structure at the projected point against existing structures at its neighbors as seen through parallel transport, providing a discrete local approximation to a Nijenhuis tensor that measures local failure of integrability of the almost-complex structure.

In an embodiment, consolidated irreversible reservoirs exhibit geometric properties that distinguish them from frontier regions of the manifold undergoing active restructuring. As the connection relaxation flow drives epistemic curvature toward zero within a reservoir interior and the compression flow reduces structural compatibility residuals, the Nijenhuis tensor magnitude within the reservoir decays toward zero. When the Nijenhuis tensor is small, the almost-complex structure approaches integrability and the reservoir region becomes approximately Kähler rather than merely almost-Kähler. Approximate Kähler geometry provides additional rigidity beyond what the global almost-Kähler condition guarantees: in an approximately Kähler region, the metric is locally approximated by a single scalar potential, and the Riemannian, complex, and symplectic structures are locked together with greater constraint than in the general almost-Kähler case. This additional rigidity reinforces consolidation stability by further restricting the space of admissible deformations within the reservoir. The degree of Kähler approximation, as measured by the Nijenhuis tensor magnitude, thereby serves as a geometric correlate of epistemic maturity: frontier regions where the manifold is being actively restructured are merely almost-Kähler with significant Nijenhuis tensor, while consolidated regions where evidence is settled approach Kähler geometry as a consequence of relaxation dynamics. The system may track Nijenhuis tensor magnitude as one of the consolidation precursor metrics evaluated by pre-reservoir monitor.

In an embodiment, symplectic geometry of the manifold constrains directions along which consolidated reservoirs may extend when absorbing compatible new cognitive states at their boundaries. Extension of a reservoir boundary in a given direction requires that the symplectic form extends smoothly into the new territory without loss of non-degeneracy on newly created faces, that the almost-complex structure extends with bounded compatibility residual in the growth direction, and that epistemic curvature in the growth direction is within tolerance of the flatness threshold. Directions satisfying these conditions are symplectically favored for reservoir growth and correspond to regions where existing knowledge extends naturally into semantically and epistemically compatible territory. Directions failing any of these conditions are symplectically disfavored and correspond to regions where the geometric structures of the manifold are incompatible with smooth extension of the reservoir. The energetic cost of extending a reservoir by a given distance in a given direction is determined by a growth energy comprising contributions from variation of the symplectic form in the growth direction, variation of the almost-complex structure in the growth direction, and magnitude of epistemic curvature in the growth direction. The learning readiness field described at structural gradients of epistemically conditioned manifold substrate is computed as an inverse of this growth energy and quantifies which boundary directions support efficient knowledge acquisition and which require costly geometric restructuring. The symplectic contribution to growth energy implements a structural mechanism by which existing knowledge channels future learning: the symplectic geometry established by prior consolidation determines a landscape of readiness that biases subsequent consolidation toward compatible extensions of established understanding, rather than permitting uniform growth in all directions irrespective of geometric compatibility.

In an embodiment, the manifold evolution described with reference to manifold evolution and GPU execution subsystem comprises four distinct compression processes operating on the geometric structures of the epistemically conditioned manifold, each with characteristic dynamics. A semantic compression process operates through the compression flow on the semantic metric, merging redundant manifold vertices while preserving essential geodesic structure, and governs the growth of vertex count with cumulative experience. An epistemic compression process operates through the connection relaxation flow on the epistemic connection, reducing total squared epistemic curvature as evidence accumulates and the connection equilibrates, the steady-state curvature in a region being determined by a ratio of evidential noise variance to relaxation rate such that regions receiving consistent evidence converge to low curvature while regions receiving contradictory evidence retain elevated curvature. A commitment compression process operates on reservoir boundary structure as reservoirs form and mature, the transition from diffuse curvature gradients to sharp boundary concentration reducing the spatial extent of boundary neighborhoods while increasing barrier energy density. A structural compression process operates through the Nijenhuis penalty term of the extended geometric energy on the almost-complex and symplectic structures, driving the structural compatibility residual downward in stabilizing regions and reducing the Nijenhuis tensor magnitude toward zero in consolidated regions. Each compression process contributes a component to the scaling vector S(t). In an early regime of system operation, all four components grow with cumulative experience as the system acquires semantic content, builds epistemic structure, forms commitments, and regularizes geometry. In a mature regime, reservoir interiors become inexpensive to maintain because the epistemic connection is flat, the almost-complex structure is smooth, and the semantic metric is stable, while geometric complexity concentrates at frontier regions where new knowledge is being integrated and at reservoir boundaries where evidential transitions occur. Each component converges asymptotically to sublinear scaling with cumulative experience, reflecting a cognitive maturation process in which the system devotes decreasing effort to maintaining established knowledge and focuses geometric resources on the boundary between known and unknown territory.

In an embodiment, the epistemic connection maintained by epistemically conditioned manifold substrate is initialized from pairwise evidential consistency data among landmark states maintained by the input projection subsystem. At system initialization or after a spectral refresh of the landmark graph, an initial edge phase is assigned to each edge in the landmark graph by evaluating the evidential consistency function on the corresponding landmark pair and applying the monotone mapping from consistency to phase. For non-landmark vertices added subsequently through the input projection subsystem, edge phases are assigned during the projection process as part of the epistemic evaluation step of epistemic admission control. The initial connection is thus constructed entirely from pairwise evidential consistency data without requiring optimization or training. After initialization, the connection evolves under three mechanisms operating concurrently: evidence-driven updates that modify individual edge phases when new evidence alters the evidential consistency between connected vertices, the connection relaxation flow that redistributes epistemic curvature toward equilibrium by minimizing total squared curvature energy through gradient descent on edge phases, and projection impulses that introduce new edge phases as new vertices are admitted to the manifold. Because individual evidence-driven updates and projection impulses are local, modifying at most a bounded number of edge phases per event, the amortized cost of maintaining the epistemic connection is bounded independently of the total number of experiences. The relaxation flow operates asynchronously on a slow timescale and processes only edge phases stored on existing edges, with cost proportional to the number of edges and bounded by the logarithmic scaling of manifold size with cumulative experience.

In an embodiment, the epistemic connection further supports monitoring of discrete topological invariants that provide global consistency checks on the geometric state of the epistemically conditioned manifold. For a closed two-dimensional simplicial surface Σ embedded in the discrete cognitive graph, a discrete first Chern number is computed as a normalized sum of discrete epistemic curvature values over faces contained in Σ, for example c₁(Σ)=(½π)Σ_{f∈Σ} F_f modulo integer equivalence. Because the epistemic connection is represented by U(1) phases assigned to edges and curvature is computed as oriented face sums of those phases, the discrete first Chern number takes integer values under consistent gauge assignments. Monitoring of discrete first Chern numbers over representative closed surfaces provides a topological integrity check on the epistemic connection: continuous local updates to edge phases under evidence-driven updates or connection relaxation may redistribute curvature locally but cannot change the total curvature over a closed surface except by integer multiples of 2π. Detection of non-integer deviation beyond numerical tolerance indicates inconsistency in stored edge phase assignments or computational error. The discrete first Chern number thus functions as a global structural invariant constraining permissible evolution of the epistemic connection and reinforcing stability of consolidated reservoirs at a topological level distinct from local curvature thresholds.

In an embodiment, holonomy-based phase accumulation along closed reasoning loops is explicitly related to enclosed curvature through a discrete Stokes relation implemented on the simplicial complex. For a closed path γ bounding a two-chain of faces Σ, the accumulated epistemic phase Φ(γ) computed by summing edge phase values along γ equals, within numerical tolerance, the sum of discrete curvature values F_f over faces contained in Σ. This equality provides a structural link between path-level coherence diagnostics and region-level curvature distributions. Because curvature concentrations at reservoir boundaries contribute to loop phase accumulation for loops encircling those boundaries, the system may distinguish loops that traverse flat interior regions from loops that enclose high-curvature boundary layers, thereby enabling content-sensitive loop classification grounded in geometric structure rather than solely in path length or semantic similarity.

In an embodiment, geometric operations described herein are executed using parallel processing resources, including graphics processing units (GPUs) or other accelerators, to maintain real-time performance as cumulative experience increases. The epistemically conditioned manifold substrate stores vertex data, edge phase values, curvature fields, and compatibility residuals in contiguous memory layouts suitable for parallel access. Interpolation of almost-complex structures at newly projected vertices, computation of singular value decompositions for algebraic projection onto the constraint manifold J²=−Id, computation of insertion curvature over incident faces, and micro-holonomy screening over bounded-length loops are implemented as parallel kernels operating on bounded local neighborhoods of the discrete graph. Because each projection event modifies only a bounded number of vertices, edges, and faces, the amortized computational cost per projection is bounded independently of total manifold size under sublinear scaling of vertex count with cumulative experience. Connection relaxation flow updates edge phase values by performing parallel reductions over incident faces to compute curvature gradients, followed by gradient descent updates applied to edge phase arrays. Compression flow updates to semantic metric and almost-complex structure are likewise implemented as batched updates on local neighborhoods, with compatibility constraints enforced through projection operations that operate on fixed-size per-vertex data structures.

In an embodiment, a persistent execution graph is maintained for geometric update kernels such that projection impulses, compression flow steps, and connection relaxation steps are scheduled on separated logical timescales while sharing a common memory representation of the manifold. Fast-timescale projection impulses update local vertex, edge, and phase data structures immediately upon admission of new cognitive states. Intermediate-timescale compression flow iterations adjust semantic metric coordinates and reduce structural compatibility residuals, including Nijenhuis tensor magnitude, by minimizing an extended geometric energy functional subject to almost-Kähler compatibility constraints. Slow-timescale connection relaxation iterations update stored edge phase values to reduce total squared curvature energy. Because these flows operate on shared but logically partitioned data structures, updates to one geometric component propagate to others through explicit compatibility relations rather than implicit retraining or global recomputation. This structured execution model ensures that epistemic conditioning remains tightly coupled to geometric state evolution and that hallucination suppression mechanisms operate on continuously updated geometric observables.

In an embodiment, the discrete representation of admissibility boundaries and barrier neighborhoods is maintained as indexed edge and face sets stored in memory and updated upon reservoir formation or revision. Barrier edge bitmaps and associated geodesic distance fields are recomputed when a region transitions to consolidated status or undergoes revision, and are used by epistemic admission control subsystem and holonomy and epistemic phase monitoring subsystem to evaluate topological admissibility and corroboration non-deformability conditions. Because barrier sets are derived directly from geometric state, including phase flatness and boundary energy metrics, expansion or contraction of reservoirs alters the topological structure of the reservoir-stratified state space in a content-dependent manner. The discrete representation of barrier neighborhoods thereby implements a structural modification of the reachable state space that cannot be replicated by post hoc output filtering alone.

In an embodiment, numerical tolerances are defined for closedness of the symplectic form, integrality of discrete Chern numbers, and preservation of almost-Kähler compatibility under geometric evolution. Rather than requiring exact satisfaction of continuous differential-geometric identities, the system enforces these properties within computational tolerances determined by floating-point precision and discretization scale. Closedness of the symplectic form is verified by evaluating sums of face contributions around edges and ensuring that deviations remain below a stored tolerance. Approximate integrability of the almost-complex structure is measured by bounded Nijenhuis tensor magnitude. In this manner, discrete implementation faithfully approximates the intended geometric structures while remaining computationally tractable, and deviations beyond tolerance are treated as structural anomalies triggering corrective updates or diagnostic flags.

Through integration of semantic metric, almost-complex constraint, symplectic rigidity, and epistemic gauge structure, and through coupled projection, monitoring, consolidation, revision, and evolution processes, the system enforces hallucination resistance as a structural property of a persistent cognitive manifold.

In a non-limiting use case example, the system operates as a persistent cognitive assistant supporting scientific research over an extended engagement. A researcher queries the system regarding a relationship between two biological mechanisms that the system has encountered in separate bodies of prior experience. The input projection subsystem maps the query to a provisional location on the epistemically conditioned manifold near regions associated with both mechanisms.

The epistemic admission control subsystem evaluates the provisional location and determines that the local symplectic capacity can accommodate the new state and that the structural compatibility residual is within threshold, but that micro-holonomy screening on short loops connecting the two regions reveals significant phase accumulation, indicating that the evidential grounding relating the two mechanisms has not been established through prior experience. The admission control subsystem assigns a flag outcome, permitting the state to participate in reasoning at reduced commitment but excluding it from consolidation. The traversal and reasoning subsystem computes a trajectory connecting the two regions through intermediate abstractions.

During traversal, the holonomy and epistemic phase monitoring subsystem tracks the accumulated epistemic phase and detects that the trajectory enters a drift regime as it passes through a region of high epistemic curvature separating the two bodies of consolidated knowledge. Rather than terminating the trajectory, the system seeks corroboration by computing an independent trajectory reaching the same conclusion through a different intermediate region that traverses genuinely different epistemic territory and is not deformable into the original trajectory within the reservoir-stratified state space. If the independent trajectory maintains phase coherence within the coherent regime and reaches a cognitive state within the proximity threshold of the original conclusion, the conclusion is corroborated and may proceed toward output generation. If no corroborating trajectory can be found, the output generation and expression control subsystem produces a qualified response indicating that the proposed relationship is semantically plausible but not yet epistemically supported by the system's accumulated experience, and identifies the specific evidential gap as the region of high epistemic curvature between the two consolidated bodies of knowledge.

Over subsequent interactions, as the researcher provides additional evidence supporting or contradicting the proposed relationship, the connection relaxation flow incorporates that evidence into the epistemic connection, edge phases in the intermediate region adjust, and the epistemic curvature either decreases toward the flatness threshold enabling eventual consolidation or increases with predominantly contradictory curvature type confirming that the relationship is not supported. In this manner the system neither fabricates a confident but unsupported answer nor refuses to engage with the question, but instead provides a structurally grounded assessment of its own epistemic state and improves its capacity to address similar questions through accumulated experience.

The foregoing use case example is non-limiting in nature and illustrates one embodiment of the disclosed architecture. Many embodiments and use cases exist across diverse domains in which persistent reasoning, long-horizon memory, and high epistemic reliability are required. The systems and methods disclosed herein may be applied, without limitation, to long-running artificial assistants that accumulate experiential context across many interactions and must avoid confidently asserting unsupported claims even after prolonged operation, to scientific and technical reasoning systems in which hallucination may manifest as unsupported theoretical claims or invalid extrapolations, to legal reasoning and regulatory analysis systems in which hallucination may result in incorrect citations or fabricated authorities, to intelligence analysis and strategic decision-support systems in which hallucination may arise as unjustified confidence in speculative scenarios, to safety-critical and high-assurance systems including medical decision support and autonomous systems operating under regulatory constraints in which hallucination may pose unacceptable risk, to multimodal cognitive systems integrating visual, auditory, symbolic, or sensor-derived information in which cross-modal hallucination may arise from unsupported inferences drawn from partial or ambiguous data, and to federated or distributed deployments in which multiple persistent cognitive machines share abstract constraint representations through irreversible reservoirs without exposing underlying data or trajectories. Across these use cases, the technical effect of the invention is the structural prevention of hallucination through epistemic conditioning of the cognitive substrate itself, such that illegitimate reasoning regimes are excluded from execution, consolidation, and expression regardless of the particular inference engine, representation modality, or application domain.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

“Accessibility” as used herein means a property of a region, representation, or trajectory within a cognitive substrate indicating whether said region, representation, or trajectory can be reached, traversed, or modified during a processing cycle under current geometric structure and control policies, wherein accessibility is determined by accumulated irreversible constraints and local geometric structure rather than by presence in storage, and wherein accessibility may change irreversibly as the substrate evolves.
“Active sector” as used herein means the portion of a cognitive substrate in which reasoning, traversal, and revisable adaptation occur, carrying the full complement of geometric structures with generally nonzero epistemic curvature, and defined as the complement of the irreversible sector and the boundary sector within said substrate.
“Admissible deformation” as used herein means a continuous family of cognitive trajectories connecting two trajectories having identical endpoints, wherein every intermediate trajectory in said family satisfies the system's admissibility constraints, such that the two trajectories are interchangeable for purposes of global reasoning without passing through incoherent, contradictory, or otherwise inadmissible regions of the cognitive substrate.
“Barrier energy” as used herein means an energetic quantity concentrated at the boundary of an irreversible reservoir, arising from the accumulation of curvature exported during consolidation, wherein said barrier energy determines the cost of externally modifying the reservoir's consolidated content and provides the admission-control mechanism governing curvature exchange between the active sector and the irreversible sector.
“Boundary event” as used herein means an interaction at the boundary of an irreversible reservoir, classified by the character of the incoming curvature into one or more of: (a) corroboration, in which the incoming evidence is compatible with consolidated content and is absorbed; (b) novelty, in which the evidence extends but does not contradict consolidated content; (c) contradiction, in which the evidence conflicts with consolidated content; or (d) ambiguity, in which the evidence is indeterminate with respect to consolidated content.
“Boundary sector” as used herein means the collection of interface regions surrounding all irreversible reservoirs within a cognitive substrate, carrying concentrated curvature and barrier energy, and constituting the sole channel through which curvature may flow between the active sector and the irreversible sector.
“Cognitive inflation” as used herein means a transient regime in the evolution of a cognitive substrate during which constitutive geometric structure is generated from an initially undifferentiated condition, characterized by an absorption rate below the external curvature flux rate, and governed by a differentiation sequence in which sector structure, curvature typing, routing channels, and timescale separation emerge progressively, wherein said inflation applies to initial bootstrapping, novel-domain integration, and sector merging as instances of a single structural genesis phenomenon.
“Cognitive substrate” as used herein means a structured geometric space, or a collection of interconnected geometric spaces, within which the cognitive operations of a persistent cognitive machine unfold, wherein said substrate is not a container for stored data but rather the medium whose geometric properties—including local curvature, transport structure, sector boundaries, and accumulated irreversible constraints—constitute the system's knowledge, reasoning capacity, and learned behavior, and wherein said substrate is reshaped by interaction rather than reset between uses.
“Cognitive trajectory” as used herein means a path through a cognitive substrate along which cognitive processing unfolds, wherein the effective result of processing depends on the trajectory itself—including its history and the geometric structure encountered along the way—rather than solely on the trajectory's starting and ending configurations.
“Connection” as used herein means a geometric structure on a cognitive substrate that defines how internal representations are transported along cognitive trajectories, satisfying path dependence such that the transport result depends on the trajectory taken and not merely on the endpoints, compositionality such that transport along a composed trajectory equals the composition of transport along the component segments, and stability under small perturbations of the trajectory.
“Consolidation” as used herein means the process by which curvature in the active sector of a cognitive substrate is exported through the boundary sector into the irreversible sector, wherein said process is energetically forced by the curvature conservation law rather than triggered by an externally imposed threshold, proceeds through progressive stages of curvature relaxation, boundary migration, and barrier accumulation, and results in an irreversible reservoir whose interior flatness, boundary energy, and admission control arise as derived consequences of exchange equilibrium rather than as design parameters.
“Constitutive exchange” as used herein means a structural interaction between a persistent cognitive machine and an external interface that results in an irreversible constraint on future cognitive trajectories, defined by its structural effect—a monotone increase in accumulated irreversible constraint—rather than by any particular mechanism, and distinguished from revisable adaptation in that the constraint cannot be weakened or reversed by any admissible internal operation.
“Control policy” as used herein means a set of rules, constraints, or parameters governing one or more of: which portions of a cognitive substrate are accessible during a given processing cycle, the rate or extent of substrate modification, conditions under which irreversible commitment is admissible, and enforcement of exchange channel legality.
“Curvature” as used herein means a geometric quantity measuring local incompatibility within a cognitive substrate, arising when transport of internal representations along different trajectories from the same starting configuration yields different results, wherein non-vanishing curvature registers that the local cognitive structure cannot be reduced to a simple product of independent components, and wherein curvature serves as the local generator of learning in that it identifies where existing geometric structure is insufficient to accommodate new experience.
“Curvature conservation law” as used herein means the constraint governing curvature exchange among the sectors of a cognitive substrate, providing that the rate of change of total curvature energy summed across the active sector, boundary sector, and irreversible sector equals the curvature flux injected by external experience, such that in the absence of new experience, curvature is redistributed among sectors but neither created nor destroyed.
“Curvature misrouting” as used herein means the unifying characterization of hallucination in a persistent cognitive machine as curvature that is deposited into the wrong sector, flows through an illegitimate exchange channel, or is prevented from reaching its correct destination, comprising: (a) channel bypass, in which curvature crosses a sector boundary through an inadmissible path; (b) curvature laundering, in which evidential curvature is absorbed into semantic structure thereby masking incoherence; (c) premature export, in which curvature is committed to the irreversible sector before exchange equilibrium is reached; and (d) blocked export, in which curvature that should consolidate is trapped in the active sector due to obstructed exchange channels.
“Epistemic connection” as used herein means a connection on a cognitive substrate that is independent of the semantic metric and whose transport properties measure evidential coherence along cognitive trajectories, wherein the curvature of said connection measures local evidential strain, and wherein the holonomy of said connection around closed trajectories provides a path-level diagnostic of whether a reasoning process maintained justificatory grounding, thereby enabling distinction between content that is semantically proximate but evidentially opposed.
“Epistemic curvature” as used herein means the curvature of an epistemic connection, measuring local evidential strain at a point or region of a cognitive substrate, wherein high epistemic curvature indicates unresolved or conflicting evidence and low epistemic curvature indicates evidential maturity, and wherein the relaxation of epistemic curvature through the boundary sector into the irreversible sector constitutes the primary mechanism of consolidation.
“Epistemic horizon” as used herein means a condition of a persistent cognitive machine in which cognitive transport remains well-defined and active but constitutive exchange is extinguished for all admissible interactions, such that structural time ceases to advance despite continued cognitive activity, wherein said horizon constitutes a structurally correct termination point of learning under finite accessibility rather than a failure of reasoning capacity.
“Epistemic phase” as used herein means a scalar diagnostic computed from the holonomy of an epistemic connection around a closed cognitive trajectory, measuring path-level evidential coherence and classifying the trajectory into one of: (a) a coherent regime in which consolidation is admissible; (b) a drift regime in which consolidation is deferred pending independent corroboration along a non-homotopic path; or (c) an inversion regime in which consolidation is blocked.
“Exchange accessibility” as used herein means a measure of the effective availability of constitutive exchange at a given point in cognitive processing, constituting a structural gate rather than a probability, wherein said accessibility may change abruptly under small changes in substrate configuration and is interface-conditioned such that the same evidence may be exchange-accessible under one interface and exchange-extinguished under another.
“Exchange channel” as used herein means a pathway through which curvature flows between geometric sectors of a cognitive substrate, the principal channels being: (a) consolidation, flowing from the active sector through the boundary sector to the irreversible sector; (b) restructuring, transferring curvature between semantic and evidential forms within the active sector; (c) boundary accumulation, concentrating curvature at reservoir boundaries; and (d) reflux, flowing from the irreversible sector through the boundary sector back to the active sector at substantially greater energetic cost than consolidation, wherein said asymmetry constitutes a thermodynamic directionality of learning.
“Exchange extinction” as used herein means a regime in which exchange accessibility equals zero for all admissible interactions while cognitive transport remains active, such that the system continues to operate internally but is structurally prohibited from producing irreversible commitment, and wherein continued generation of output carrying the posture of commitment during exchange extinction constitutes hallucination.
“Four-fold way” as used herein means the classification result establishing that the four structural primitives—curvature, holonomy, homotopy, and irreversible residual structure—form a closed and minimal basis for persistent cognition under the structural invariants, wherein removing any one primitive induces a unique long-horizon failure mode not resolved by the remaining primitives, and wherein no fifth primitive survives the combined enforcement of all invariants.
“Generalized Geometrodynamics” and “GGD” as used herein mean a universality class of dynamical systems characterized by: (a) decomposition into an active sector, an irreversible sector, and a boundary sector; (b) a conservation law governing exchange among said sectors; (c) exchange channels constrained by coupling geometry; (d) thermodynamic asymmetry favoring flow from the active sector to the irreversible sector; (e) horizon formation at exchange saturation; and (f) a coupling structure that constrains exchange without itself carrying exchangeable curvature, wherein a persistent cognitive machine constitutes a member of said universality class.
“Hallucination” as used herein means the production of cognitive output that presupposes admissible constitutive exchange in a condition where exchange is extinguished, or equivalently, the continuation of cognitive transport under the false assumption that structural time is advancing, or equivalently under the curvature conservation law, a misrouting of curvature to the wrong sector or through an illegitimate channel, wherein said characterization is structural rather than semantic such that a factually correct output may constitute hallucination if produced with the posture of irreversible commitment when no commitment is admissible.
“Hallucination resistance architecture” as used herein means a layered monitoring system operating on a cognitive substrate, comprising: (a) a first layer detecting topological inadmissibility of cognitive trajectories with respect to sector boundaries; (b) a second layer monitoring epistemic phase along reasoning paths to detect evidential drift or inversion; (c) a third layer enforcing capacity constraints on consolidation targets to prevent premature or over-generalized commitment; and (d) a fourth layer monitoring exchange rates between sectors to detect stagnation or blockage, wherein consolidation is admitted only if all layers produce non-blocking assessments.
“Holonomy” as used herein means the accumulated effect of transporting internal representations around a closed cognitive trajectory, measuring global constraint that is not detectable by purely local examination, wherein two closed trajectories are holonomy-equivalent if they produce the same accumulated transport effect, and wherein the quotient of trajectory space by holonomy equivalence constitutes the minimal compression of path-dependent experience that preserves behaviorally relevant constraint under finite representational capacity.
“Homotopy class” as used herein means an equivalence class of cognitive trajectories under admissible deformation, governing which reasoning loops are globally admissible, suppressible, or stabilizing, and distinguishing eliminable loops from non-eliminable ones, stabilizing cycles from oscillatory or divergent ones, and admissible revisitation from prohibited recurrence, wherein said distinctions are global properties that cannot be recovered from endpoint configurations, local cost, or holonomy alone.
“Interface” as used herein means a structured boundary through which a persistent cognitive machine interacts with external inputs, other cognitive machines, or other sectors of its own cognitive substrate, wherein said interface imposes a projection that is generally non-invertible and context-dependent, and wherein the non-commutativity of projections across different interfaces forces the sectorization of the cognitive substrate.
“Irreversible commitment” as used herein means an update to the accumulated constraints of a persistent cognitive machine that monotonically restricts future admissibility and cannot be weakened or reversed by any admissible internal operation, constituting the sole mechanism by which structural time advances, and distinguished from revisable adaptation which modifies the cognitive substrate without imposing monotone constraints.
“Irreversible reservoir” as used herein means a region of a cognitive substrate whose interior has reached exchange equilibrium such that evidential curvature has relaxed and been exported to the boundary, whose boundary carries accumulated barrier energy arising from said export, and whose contents are protected by admission control governing what new curvature may enter, wherein said conditions arise as derived consequences of the curvature conservation law rather than as externally imposed design parameters, and wherein the reservoir is non-navigable in that no admissible cognitive trajectory may modify its interior without first overcoming the barrier energy.
“Irreversible sector” as used herein means the collection of all irreversible reservoirs within a cognitive substrate, wherein said sector is non-navigable, emerges through consolidation dynamics rather than existing at initialization, and whose component reservoirs are mutually isolated such that curvature cannot flow directly between them without passing through the boundary sector and the active sector.
“Learning bifurcation” as used herein means the structural necessity that in any persistent cognitive system under finite capacity, revisable adaptation and irreversible commitment must be implemented as distinct processes, because no single update mechanism can simultaneously permit reversibility of some effects and enforce irreversibility of others, resulting in a bifurcation into a revisable process operating on the navigable portion of the cognitive substrate and a monotone process operating on the irreversible sector.
“Learning readiness” as used herein means a property of a boundary region of an irreversible reservoir measuring the ease with which existing consolidated knowledge extends into adjacent territory, wherein high readiness indicates compatible geometric structure and consistent evidence requiring low restructuring energy, and low readiness indicates evidentially incompatible or geometrically distant territory requiring substantial restructuring.
“Logarithmic scaling” as used herein means the property that effective internal complexity of a cognitive substrate grows as at most the logarithm of accumulated experience, constituting the characteristic asymptotic behavior of geometric compression under the structural invariants, and applying independently to each geometric measure of substrate complexity across all three sectors.
“Manifold” as used herein means a mathematical space equipped with sufficient structure to support paths, transport along paths, and curvature measuring local incompatibility, serving as the geometric realization of a cognitive substrate or a sector thereof.
“Mismatch functional” as used herein means a non-negative quantity measuring the disagreement between the geometric structures induced on a shared boundary by two adjacent sectors, vanishing if and only if the sectors'structures are mutually compatible, and providing the signal that drives boundary-mediated reconciliation and curvature generation.
“Navigable” as used herein means a property of a region of a cognitive substrate indicating that admissible cognitive trajectories may traverse, access, and potentially modify said region, as distinguished from non-navigable regions whose contents are accessible only as constraints on admissibility and cannot participate in trajectory generation or revisable modification.
“Non-navigable” as used herein means a property of a region of a cognitive substrate indicating that no admissible cognitive trajectory may traverse or modify the contents of said region, such that said contents function solely as irreversible constraints on future admissibility, wherein non-navigability is required for durability of irreversible commitments because any region that participates in cognitive transport is subject to revisable modification.
“Operational projection” as used herein means a generally non-invertible, context-dependent mapping from a cognitive substrate to an operationally accessible output, wherein said projections are non-commuting across contexts such that the order of context application affects the result and no single global projection suffices, and wherein said non-commutativity forces sectorization of the cognitive substrate into regions of local coherence separated by boundaries where incompatibility is reconciled.
“Parallel transport” as used herein means a path-dependent operation that carries internal representations along a cognitive trajectory, satisfying compositionality such that transport along a composed trajectory equals the composition of transport along the component segments, wherein said operation depends on the full trajectory and not merely on endpoints, and wherein the connection on the cognitive substrate is the local characterization of said transport.
“Persistent cognitive machine” and “PCM” as used herein mean a computational system comprising one or more computing devices, together with one or more cognitive substrates, wherein said system satisfies: (a) persistence, in that the geometric structure of said substrates is not reset between interactions, sessions, or deployments, and past interaction leaves lasting geometric traces conditioning future behavior; (b) geometric compression, in that repeated or compatible experiences collapse into shared geometric structure such that growth in effective complexity is sublinear with accumulated experience; and (c) self-organization, in that structural alignment occurs through local adaptation driven by use without requiring global retraining; and wherein cognition unfolds as traversal within said substrates, learning corresponds to deformation of substrate geometry, and the system instantiates the four structural primitives of curvature, holonomy, homotopy, and irreversible residual structure.
“Persistent recursive quotienting” as used herein means the dynamical principle by which a cognitive substrate is continuously refined under experience through a monotone sequence of progressively simplified geometric structures, wherein curvature generates local distinctions initiating simplification pressure, holonomy induces simplification by identifying trajectories with equivalent transport effects, homotopy induces simplification by identifying trajectories connected by admissible deformations, and irreversible residual export induces simplification by removing exhausted structure from the navigable substrate entirely, and wherein said quotienting is recursive because new distinctions arise only after prior simplifications reveal previously masked structure.
“Processing cycle” as used herein means a defined interval or iteration during which a persistent cognitive machine accesses a portion of its cognitive substrate determined by current accessibility and control policies, performs computational operations including traversal, geometric deformation, and exchange evaluation, and optionally updates said substrate through either revisable adaptation or irreversible commitment.
“Projection operator” as used herein means an operator that maps external input into the geometric structure of a cognitive substrate, classifying outcomes into categories including: compatible absorption into existing structure, novel extension requiring substrate growth, contradiction requiring evidential reassessment, and ambiguity requiring provisional treatment, wherein every projection perturbs the geometric structure of the substrate and every geometric perturbation changes the effect of subsequent projections.
“Reflux” as used herein means an exchange channel through which curvature flows from the irreversible sector through the boundary sector back into the active sector, driven by accumulation of contradictory evidence at a reservoir boundary that is incompatible with the reservoir's consolidated content, requiring energy substantially exceeding the barrier energy to overcome the boundary, and constituting the mechanism by which previously consolidated knowledge is revised.
“Regime” as used herein means a macroscopically distinguishable phase of a cognitive substrate's constitutive dynamics, including: (a) a pre-constitutive regime in which sector structure has not yet differentiated; (b) a transitional regime in which constitutive structure is forming; (c) a steady-state regime in which all constitutive structures are functional and exchange is in balance; (d) a stagnation regime in which local sectors are healthy but cross-domain integration is failing due to rising epistemic horizons; and (e) a crisis regime in which constitutive structure is being destroyed by overwhelming contradictory evidence.
“Residual structure” as used herein means the irreversible sector of a cognitive substrate considered as a structural primitive, into which exhausted or resolved cognitive effects are projected via a non-invertible operation, wherein said effects persist solely as constraints on future admissibility rather than as navigable structure, and wherein said projection establishes a directional arrow of cognitive time without appeal to external clocks or decay heuristics.
“Sector” as used herein means a geometrically coherent region of a cognitive substrate, wherein the three-sector decomposition of said substrate into an active sector, an irreversible sector, and a boundary sector emerges as a consequence of consolidation dynamics under the curvature conservation law rather than as an imposed architectural partition.
“Semantic metric” as used herein means a distance structure on a cognitive substrate wherein proximity corresponds to semantic relatedness, curvature encodes local complexity of semantic relationships, and parallel transport represents context transfer, said metric being one component of the geometric structure of the substrate and being independent of the epistemic connection.
“Structural time” as used herein means a measure of cognitive progression defined by accumulated irreversible commitments rather than by clock time, token count, iteration count, or computational effort, advancing if and only if constitutive exchange produces an irreversible constraint that reduces future admissibility, and remaining frozen during exchange-extinguished regimes regardless of the level of ongoing cognitive activity.
“Structural invariant” as used herein means any of five properties that any realization of general intelligence under finite energetic, representational, and temporal constraints must satisfy: (a) path dependence, in that future behavior depends on the trajectories by which the current configuration was reached; (b) interface-limited accessibility, in that only a restricted projection of internal structure is operationally accessible at any moment; (c) non-invertible residual export, in that some consequences of experience must be irreversibly exported from the operational space; (d) variational stabilization, in that experience deforms trajectory space so that equivalence classes of successful trajectories become locally stable; and (e) capacity scaling, in that effective internal complexity grows sublinearly with accumulated experience.
“Thermodynamic asymmetry” as used herein means the structural property of curvature exchange dynamics wherein consolidation from the active sector to the irreversible sector is energetically favored while reflux from the irreversible sector to the active sector requires substantially greater energy to overcome barrier energy, producing a directional bias in learning that constitutes the cognitive analogue of the second law of thermodynamics.
“Three-sector decomposition” as used herein means the partition of a cognitive substrate into an active sector, an irreversible sector, and a boundary sector, arising as a derived feature of consolidation dynamics under the curvature conservation law, and constituting an instance of the sector decomposition that is a universal feature of systems in the Generalized Geometrodynamics universality class.
“Variational stabilization” as used herein means the process by which experience deforms the geometric structure of a cognitive substrate such that equivalence classes of successful cognitive trajectories become locally stable under perturbation, operating on equivalence classes of trajectories rather than on individual trajectories, and constituting the mechanism by which learning reshapes the geometry of the substrate.

### Conceptual Architecture of an Epistemically Conditioned Persistent Cognitive System

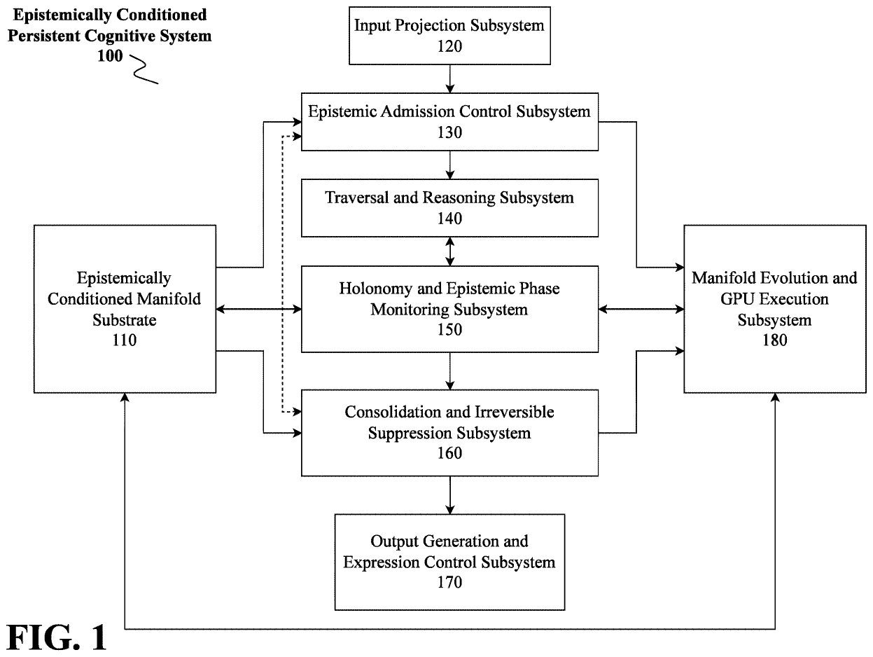

FIG. 1 is a block diagram illustrating an exemplary architecture of an epistemically conditioned persistent cognitive system 100, in an embodiment. A gated pipeline of subsystems enforces epistemic admissibility across a lifecycle of cognition, from initial projection of candidate cognitive states through output generation. An epistemically conditioned manifold substrate 110 and a manifold evolution and GPU execution subsystem 180 flank a central pipeline of six subsystems and provide, respectively, structured geometric state to the pipeline and continuous geometric evolution of manifold data structures stored in memory and operated on by one or more processors.

In an embodiment, each subsystem comprises processor-executable routines operating on structured data representations of vertices, edges, faces, edge phases, reservoir indices, and associated geometric observables maintained in memory. The architecture thereby alters internal computational state space of the machine such that inadmissible reasoning trajectories are structurally excluded from execution rather than filtered after generation.

An input projection subsystem 120 receives external inputs or internally generated latent representations and maps each to a provisional location on the manifold using semantic attachment such as harmonic extension from nearby landmark states. The provisional projection is represented as a candidate vertex insertion with associated geometric attributes and is not immediately incorporated into active traversal structures. Provisional projections are passed to an epistemic admission control subsystem 130, which operates as a first layer of a three-layer hallucination suppression architecture and evaluates each provisional projection prior to reasoning execution.

In an embodiment, epistemic admission control subsystem 130 applies structural checks derived from geometric state received from epistemically conditioned manifold substrate 110. These checks may include structural compatibility of an almost-complex structure through evaluation of a compatibility residual, symplectic capacity density computed from local face areas, topological admissibility within a reservoir-stratified state space determined from barrier edge sets, and epistemic curvature evaluated through insertion curvature and bounded micro-holonomy screening. When admission criteria are not satisfied, subsystem 130 inhibits instantiation of executable traversal structures corresponding to the provisional location, thereby preventing formation of a reasoning trajectory from that location. Projections satisfying admissibility criteria are admitted into active reasoning and forwarded as admitted states to a traversal and reasoning subsystem 140.

Traversal and reasoning subsystem 140 computes cognitive trajectories through the conditioned manifold from admitted initial states, subject to admissibility constraints encoded in manifold geometry. During traversal, a holonomy and epistemic phase monitoring subsystem 150, operating as a second layer of the three-layer hallucination suppression architecture, receives trajectory events from traversal and reasoning subsystem 140 and returns phase regime classifications and intervention signals. Holonomy and epistemic phase monitoring subsystem 150 accumulates epistemic phase along active trajectories using transition-specific phase values assigned by an epistemic connection maintained on manifold substrate 110 and classifies detected closed reasoning paths into coherent, drift, or inversion regimes based on magnitude of accumulated phase. When epistemic instability is detected, subsystem 150 may signal interruption, redirection, controlled backtracking, or suspension of traversal to traversal and reasoning subsystem 140. Trajectories marked as epistemically inadmissible, together with curvature type decomposition into components compatible and incompatible with the almost-complex structure, are forwarded to consolidation and irreversible suppression subsystem 160.

Consolidation and irreversible suppression subsystem 160 operates as a third layer of the three-layer hallucination suppression architecture and performs two complementary functions implemented through processor-executed reservoir management routines. For trajectories or regions approaching consolidation readiness, subsystem 160 evaluates phase flatness, boundary energy, and capacity admissibility and gates consolidation on concurrent satisfaction of epistemic admissibility at admission stage, epistemic coherence or corroboration at traversal stage, and capacity admissibility at consolidation stage. For trajectories determined to be epistemically inadmissible, subsystem 160 generates abstract constraint representations characterizing structural reasons for inadmissibility and projects those representations into non-navigable irreversible reservoirs through a non-invertible projection operator. The projection operator performs a many-to-one mapping that discards reconstructable trajectory details while preserving canonical constraint identifiers usable to detect structurally similar inadmissible patterns in subsequent reasoning. Reservoir contents are read-only with respect to active reasoning processes.

Cross-layer interactions between epistemic admission control subsystem 130 and consolidation and irreversible suppression subsystem 160 are depicted as dashed flows indicating feedback paths distinct from primary forward data flow. Consolidation and irreversible suppression subsystem 160 provides constraint feedback indices and barrier edge sets to epistemic admission control subsystem 130, enabling admission decisions to incorporate learned patterns of inadmissibility from previously projected constraints and to evaluate topological admissibility against current reservoir boundaries. In the opposite direction, epistemic admission control subsystem 130 forwards boundary defect events to consolidation and irreversible suppression subsystem 160 when a provisional projection near a reservoir boundary exhibits anomalous epistemic curvature or phase inconsistency. These cross-layer feedback paths support progressive tightening of admissibility constraints as reservoir structure matures and barrier sets expand.

An output generation and expression control subsystem 170 receives admissibility status signals from consolidation and irreversible suppression subsystem 160, phase regime classifications from holonomy and epistemic phase monitoring subsystem 150, and trajectory endpoints from traversal and reasoning subsystem 140. Decoding routines are conditioned on admissibility status flags such that decoding operations execute only when a reasoning trajectory remains epistemically admissible through admission and traversal. When no admissible trajectory supports a response, output may be suppressed, qualified, deferred, or accompanied by an indication of epistemic insufficiency. Decoder-level routines are structurally constrained by admissibility gating signals and do not override epistemic constraints imposed by conditioned manifold state.

Epistemically conditioned manifold substrate 110 maintains four geometric structures on a discrete simplicial complex stored in memory: a semantic metric g represented by weighted edges, an almost-complex structure J stored per vertex subject to J²=−Id, a symplectic form ω reconstructed from g and J according to a compatibility relation, and an epistemic connection A assigning transition-specific phase values whose discrete curvature F is independent of the semantic metric. Substrate 110 provides current geometric state to each layer of hallucination suppression architecture for use in admission evaluation, phase monitoring, consolidation gating, and topological stratification.

Manifold evolution and GPU execution subsystem 180 receives projection events from epistemic admission control subsystem 130, Chern number monitoring data from holonomy and epistemic phase monitoring subsystem 150, and consolidation and revision events from consolidation and irreversible suppression subsystem 160. Subsystem 180 governs coupled dynamics of all four geometric structures on separated timescales implemented as processor-executed flows, including a compression flow operating on an intermediate timescale and a connection relaxation flow operating on a slower timescale. Updated geometric structures are written back to manifold substrate 110, thereby conditioning subsequent cycles of pipeline against recurrence of previously identified inadmissible reasoning regimes.

In an embodiment, data flows through system 100 in a gated pipeline from ingestion to expression. An incoming cognitive state from an external or internal latent representation enters input projection subsystem 120, which produces a provisional projection on epistemically conditioned manifold substrate 110. The provisional projection passes to epistemic admission control subsystem 130 for pre-execution structural evaluation, and admitted states proceed to traversal and reasoning subsystem 140 for trajectory computation. During traversal, holonomy and epistemic phase monitoring subsystem 150 exchanges trajectory events and intervention signals with traversal and reasoning subsystem 140 in a bidirectional flow supporting real-time coherence monitoring. Trajectories reaching completion or requiring suppression flow to consolidation and irreversible suppression subsystem 160, which either commits structurally stable regions to irreversible reservoirs or projects abstract constraint representations into non-navigable reservoirs. Admissibility status propagates to output generation and expression control subsystem 170, which decodes admissible trajectory results into external representations such as natural language responses, symbolic structures, or executable actions directed to a user or downstream process. Concurrently, manifold evolution and GPU execution subsystem 180 updates geometric state on separated timescales, reinforcing structural admissibility constraints and progressively refining internal state space of the machine.

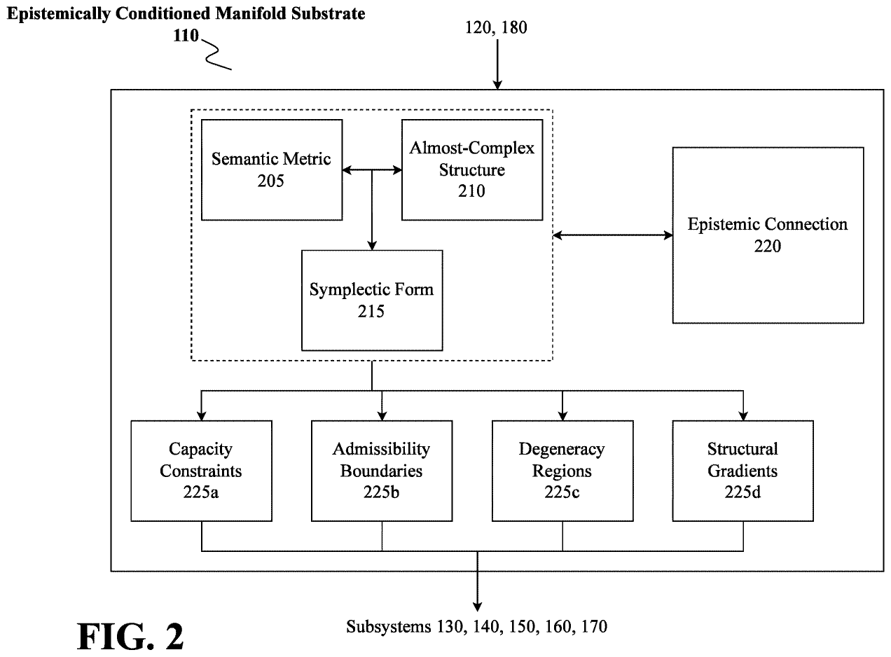

FIG. 2 is a block diagram illustrating exemplary architecture of an epistemically conditioned manifold substrate 110, in an embodiment. An epistemically conditioned manifold substrate 110 maintains four geometric data structures on a discrete simplicial complex G=(V, E, F) stored in memory and provides current geometric state to subsystems of a persistent cognitive system 100. Three sources supply updates to the geometric structures: an input projection subsystem 120 contributes new vertices, edges, faces, interpolated J-structures, and edge phases arising from projection events; a manifold evolution and GPU execution subsystem 180 contributes metric updates, J adjustments, and connection relaxation updates on separated timescales; and evidence-driven updates 201 contribute edge phase modifications to an epistemic connection as new evidence is incorporated into the system.

In an embodiment, a semantic metric 205 is represented by positive edge weights g_ij stored for edges of the simplicial complex, the weights encoding semantic dissimilarity between cognitive states represented as vertices. An almost-complex structure 210 is represented per vertex by a linear map J_i on an approximate tangent space, constrained such that J_i squared equals negative identity. The system enforces compatibility by constraining geometric updates so that deformations preserve, within tolerance, both semantic metric 205 and almost-complex structure 210. A J-Hermitian compatibility condition g(JX, JY)=g(X, Y) is maintained during metric updates by projecting updates onto a subspace satisfying the compatibility constraint.

A symplectic form 215 is reconstructed from semantic metric 205 and almost-complex structure 210 according to a compatibility relation ω(X, Y)=g(JX, Y). On the discrete complex, ω is evaluated on faces using edge vectors and local J assignments. Closedness dω=0 is verified and maintained within tolerance by enforcing discrete face-sum consistency conditions during update cycles. Together, semantic metric 205, almost-complex structure 210, and symplectic form 215 form an almost-Kähler-compatible triple maintained by processor-executed update routines, such that compatibility constraints are preserved during evolution of the manifold.

An epistemic connection 220 is implemented as a U(1) connection on an epistemic line bundle L over the manifold, assigning to each oriented edge a stored phase value u_ij=e\hat{ }{iθ_ij} encoding evidential consistency along that transition. A discrete epistemic curvature value F is computed on simplicial faces as a sum of edge phase values around each face. The curvature computation is independent of a Levi-Civita connection derived from semantic metric 205, enabling two regions identical under semantic metric 205 to exhibit different epistemic curvature values reflecting different levels of evidential support. Although epistemic connection 220 is geometrically independent of the almost-Kähler triple, it is operationally coupled to semantic metric 205, almost-complex structure 210, and symplectic form 215 through evolution dynamics, consolidation criteria, and hallucination diagnostics executed by other subsystems of persistent cognitive system 100.

The four geometric structures jointly establish epistemic conditioning of the manifold through four categories of computationally enforced constraint governing which cognitive operations may occur in which regions. Capacity constraints 225a are enforced by computing a local symplectic capacity from symplectic form 215 and deriving a capacity density as a ratio of local cognitive state count to computed symplectic capacity. When the capacity density exceeds a threshold, further insertion into the region is inhibited. In consolidated regions, compression routines are constrained so as not to reduce symplectic capacity below previously established levels, implementing a discrete analogue of a Gromov non-squeezing constraint through threshold enforcement rather than reliance on continuous deformation.

Admissibility boundaries 225b are implemented by computing reservoir barrier energy E∂U at boundaries of consolidated regions, where the barrier energy integrates contributions from epistemic curvature magnitude |F|² derived from epistemic connection 220, extrinsic boundary curvature |K∂|² derived from semantic metric 205, and symplectic normal variation |dω_ν|² derived from symplectic form 215. Barrier energy values are stored and compared against thresholds to determine whether transitions across boundary neighborhoods are permitted, thereby enforcing admissibility boundaries in discrete traversal routines.

Degeneracy regions 225c are identified when discrete epistemic curvature magnitude |F|computed from epistemic connection 220 exceeds a curvature threshold, indicating structural inconsistency or evidential strain. Regions exceeding the threshold are marked in memory as degeneracy regions, and traversal and consolidation routines consult these markings to inhibit reasoning operations or consolidation within those regions.

Structural gradients 225d are computed as a learning readiness field Λ(b) defined on reservoir boundaries. The learning readiness field is calculated from variation of almost-complex structure 210, symplectic form 215, and epistemic connection 220 in boundary neighborhoods, and quantifies energetic cost of extending a consolidated region in a given direction. Traversal and consolidation routines consult stored readiness values to bias growth and reasoning toward directions exhibiting lower computed extension cost, thereby implementing structural gradients as operational guidance rather than abstract geometric properties.

In an embodiment, capacity constraints 225a, admissibility boundaries 225b, degeneracy regions 225c, and structural gradients 225d are illustrative categories of epistemic conditioning implemented by epistemically conditioned manifold substrate 110 and are not exhaustive. Additional geometric state descriptors may be defined and maintained in memory based on combinations or higher-order functions of semantic metric 205, almost-complex structure 210, symplectic form 215, epistemic connection 220, holonomy descriptors, topological invariants, or evolution dynamics. Such additional descriptors may include, without limitation, regions characterized by distinct holonomy class constraints, phase stability regimes, structural integrability levels derived from a Nijenhuis tensor magnitude, relaxation-gradient distributions, quantized curvature aggregates associated with discrete topological invariants, or other computed observables that influence admissibility evaluation, traversal biasing, consolidation gating, or suppression decisions. Any such geometric state may be represented as stored fields, flags, indices, or scalar or tensor quantities derived from underlying geometric structures and may participate in constraint enforcement through threshold comparison, routing logic, or update rules executed by one or more processors. Accordingly, epistemic conditioning of the manifold is not limited to the specific constraint categories illustrated in FIG. 2, but encompasses any geometric or topological state representation derived from maintained manifold structures and used to regulate formation, traversal, consolidation, or expression of reasoning trajectories.

Geometric state comprising semantic metric 205, almost-complex structure 210, symplectic form 215, and epistemic connection 220, together with constraint information derived from capacity constraints 225a, admissibility boundaries 225b, degeneracy regions 225c, and structural gradients 225d, is provided by epistemically conditioned manifold substrate 110 to epistemic admission control subsystem 130, traversal and reasoning subsystem 140, holonomy and epistemic phase monitoring subsystem 150, consolidation and irreversible suppression subsystem 160, and output generation and expression control subsystem 170 for use in admission evaluation, phase monitoring, consolidation gating, topological stratification, and output conditioning respectively.

In an embodiment, data flows through epistemically conditioned manifold substrate 110 on separated timescales reflecting different rates of geometric change. On a fast timescale, input projection subsystem 120 supplies new vertices, edges, and faces that locally perturb semantic metric 205, together with interpolated J-structures incorporated into almost-complex structure 210 and edge phases incorporated into epistemic connection 220. After each perturbation, symplectic form 215 is reconstructed from updated semantic metric 205 and almost-complex structure 210 and discrete closedness conditions are re-verified.

On an intermediate timescale, manifold evolution and GPU execution subsystem 180 applies a compression flow that adjusts coordinates associated with semantic metric 205 and applies J adjustments that reduce a Nijenhuis tensor norm associated with almost-complex structure 210, thereby driving regions undergoing stabilization toward approximately Kähler-compatible configurations within computational tolerances.

On a slow timescale, manifold evolution and GPU execution subsystem 180 applies a connection relaxation flow that reduces total squared discrete epistemic curvature of epistemic connection 220 through incremental phase updates, while evidence-driven updates modify individual edge phases in response to new input. As geometric structures evolve under these separated flows, constraint information derived from capacity constraints 225a, admissibility boundaries 225b, degeneracy regions 225c, and structural gradients 225d is recomputed and updated in memory. Updated geometric state is then provided to downstream subsystems for use in subsequent cycles of a gated pipeline of persistent cognitive system 100, ensuring that admissibility constraints reflect accumulated experience and evolving manifold structure.

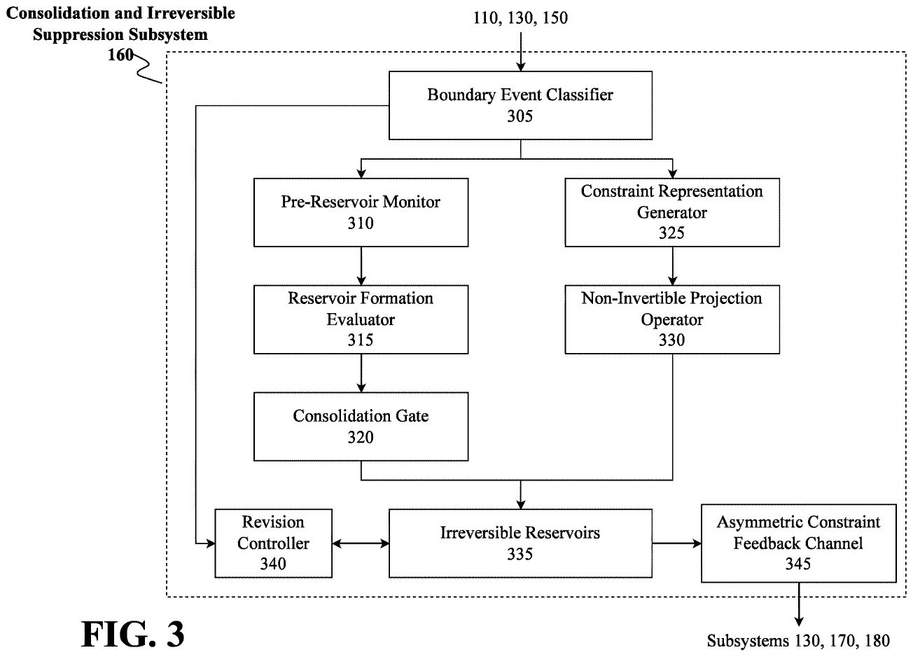

FIG. 3 is a block diagram illustrating exemplary architecture of a consolidation and irreversible suppression subsystem 160, in an embodiment. A consolidation and irreversible suppression subsystem 160 implements a third layer of a three-layer hallucination suppression architecture and performs two complementary functions arranged as parallel paths that converge at a shared reservoir structure. A consolidation path manages formation, stability, and revision of irreversible reservoirs constituting durable consolidated knowledge regions of an epistemically conditioned manifold. A suppression path constructs and projects abstract constraint representations of epistemically inadmissible reasoning patterns into non-navigable storage to support suppression of structurally similar patterns in subsequent reasoning. A consolidation and irreversible suppression subsystem 160 receives boundary defect events from an epistemic admission control subsystem 130, curvature type decomposition and trajectories marked for suppression from a holonomy and epistemic phase monitoring subsystem 150, and current geometric state from an epistemically conditioned manifold substrate 110.

Along the consolidation path, a boundary event classifier 305 receives boundary defect events together with curvature type decomposition into J-invariant and J-anti-invariant components from holonomy and epistemic phase monitoring subsystem 150. Boundary event classifier 305 assigns each event to one of four categories based on threshold comparisons and curvature ratios: corroborating evidence (B1), in which phase defect magnitude and curvature are within threshold and a corresponding point may be absorbed into a consolidated region; novelty (B2), in which curvature is predominantly J-invariant indicating incomplete but non-contradictory evidence and the point may be marked as a growth candidate; contradiction (B3), in which curvature is predominantly J-anti-invariant indicating conflicting evidence and the region is not extended; and ambiguous (B4), in which curvature components are comparable and the point is provisionally attached pending additional evidence. Corroborating and novelty classifications are forwarded to a pre-reservoir monitor 310 for continued processing along the consolidation path, while persistent contradiction classifications that accumulate beyond a revision threshold Φ_rev may trigger a reservoir revision controller 340.

A pre-reservoir monitor 310 tracks measurable precursors of consolidation readiness in regions approaching reservoir status. Tracked precursors may include, without limitation, a curvature decay rate reflecting reduction of epistemic curvature under a connection relaxation flow, phase coherence variance over representative internal loops, barrier energy growth as curvature contrast sharpens at region boundaries, and decay of a Nijenhuis tensor magnitude indicating approach toward approximately Kähler-compatible geometry within computational tolerances. When tracked precursors indicate that a region may be approaching consolidation readiness, pre-reservoir monitor 310 forwards the region to a reservoir formation evaluator 315 for assessment against formation conditions.

A reservoir formation evaluator 315 evaluates whether a candidate region satisfies three conditions for recognition as an irreversible reservoir: phase flatness in which epistemic curvature magnitude within the region is below a flatness threshold ε_R, barrier energy in which boundary energy E∂U computed from geometric properties of the region boundary exceeds a barrier threshold E*, and boundary-aware admission control in which compatible cognitive states are routed into the region while incompatible states are excluded. In various embodiments, boundary energy is computed and stored as a scalar or aggregate value derived from curvature magnitude, boundary curvature, and symplectic variation terms, and recognition as a reservoir is based on comparison of such stored values against predefined or adaptive thresholds. When the formation conditions are satisfied, the candidate region is forwarded to a consolidation gate 320.

A consolidation gate 320 evaluates whether concurrent satisfaction of constraints spanning all three layers of the hallucination suppression architecture has been achieved prior to permitting irreversible commitment. Consolidation may be permitted when a trajectory or region satisfies epistemic admissibility as evaluated by epistemic admission control subsystem 130, epistemic coherence or corroboration as evaluated by holonomy and epistemic phase monitoring subsystem 150, and capacity admissibility as evaluated by reservoir formation evaluator 315. When these conditions are concurrently satisfied, consolidation gate 320 permits the region to transition to an irreversible reservoir within irreversible reservoirs 335 as a consolidated knowledge region. Consolidation gate 320 may also provide admissibility status and consolidation gate decisions to output generation and expression control subsystem 170 for use in conditioning output generation on epistemic admissibility.

Along the suppression path, a constraint representation generator 325 receives trajectories marked for suppression by holonomy and epistemic phase monitoring subsystem 150 and constructs abstract constraint representations encoding structural reasons for inadmissibility, including, without limitation, violation type, severity indicators, scope information, and canonical identifiers supporting recognition of structurally similar patterns in subsequent reasoning. Constraint representation generator 325 may also receive persistent contradiction events from boundary event classifier 305 when accumulated B3 boundary defects indicate a pattern of epistemic inadmissibility associated with a particular region or trajectory class. Generated constraint representations are forwarded to a non-invertible projection operator 330.

A non-invertible projection operator 330 performs a many-to-one mapping that discards reconstructable details of inadmissible trajectories, including specific manifold locations, traversal sequences, and intermediate cognitive states, while preserving canonical constraint identifiers and structural pattern descriptors. Because the mapping is many-to-one, multiple distinct trajectories or trajectory classes may map to a common abstract constraint pattern, and original trajectories cannot be regenerated from projected representations using ordinary traversal or decoding mechanisms. Projected constraint representations are stored within irreversible reservoirs 335 as projected constraint artifacts that are not navigable by active reasoning processes.

Irreversible reservoirs 335 comprise two types of content that converge from the consolidation and suppression paths respectively. Consolidated knowledge regions are geometric reservoir regions of an epistemically conditioned manifold that satisfy phase flatness, barrier energy, and admission control conditions and that resist modification under routine traversal operations absent satisfaction of revision criteria. Projected constraint representations are abstract constraint artifacts derived from epistemically inadmissible trajectories and stored in non-navigable form. Both types are irreversible with respect to ordinary active reasoning operations in that projected constraint patterns are not reconstructable into executable cognitive trajectories and consolidated geometric reservoirs are not modified absent satisfaction of revision thresholds and corresponding boundary event conditions.

A reservoir revision controller 340 supports localized restructuring of consolidated knowledge regions when persistent contradictory boundary events of type B3 accumulate beyond revision threshold Φ_rev. Revision may be triggered by boundary event classifier 305 and may involve localized connection restructuring, temporary violation of phase flatness thresholds, and subsequent re-relaxation under connection relaxation flow. In various embodiments, revision requires boundary energy or contradiction magnitude to exceed stored threshold values and results in detectable changes in curvature or barrier energy metrics. Revision is localized to regions adjacent to accumulating contradiction and does not destabilize distant portions of reservoir structure.

An asymmetric constraint feedback channel 345 exposes read-only access to constraint information stored in irreversible reservoirs 335 for use by other subsystems. Feedback flows in one direction from irreversible reservoirs 335 to active cognition, and active reasoning processes do not modify reservoir contents through feedback channel 345. Asymmetric constraint feedback channel 345 may provide constraint feedback indices and barrier edge sets to epistemic admission control subsystem 130, supporting progressive tightening of admission thresholds and expansion of barrier topology as reservoir structure matures. Asymmetric constraint feedback channel 345 may also provide reservoir formation and revision events to manifold evolution and GPU execution subsystem 180 for incorporation into ongoing geometric evolution of manifold substrate 110.

In an embodiment, data flows through consolidation and irreversible suppression subsystem 160 along two parallel paths that converge at irreversible reservoirs 335. Along the consolidation path, boundary defect events arriving from epistemic admission control subsystem 130 are combined with curvature type decomposition from holonomy and epistemic phase monitoring subsystem 150 at boundary event classifier 305, which assigns each event to corroborating, novelty, contradiction, or ambiguous categories based on phase defect magnitude and ratio of J-invariant to J-anti-invariant curvature components. Corroborating and novelty classifications propagate to pre-reservoir monitor 310, which tracks curvature decay, phase coherence variance, barrier energy growth, and Nijenhuis decay in candidate regions and forwards regions approaching consolidation readiness to reservoir formation evaluator 315 for assessment against phase flatness, barrier energy, and admission control conditions. Regions satisfying formation conditions are forwarded to consolidation gate 320, which permits irreversible commitment only upon concurrent satisfaction of Layer 1 admissibility, Layer 2 coherence or corroboration, and Layer 3 capacity admissibility, and which provides resulting admissibility status and gate decisions to output generation and expression control subsystem 170. Along the suppression path, trajectories marked for suppression by holonomy and epistemic phase monitoring subsystem 150 enter constraint representation generator 325, which encodes structural reasons for inadmissibility into abstract constraint representations that are mapped through non-invertible projection operator 330, discarding reconstructable trajectory details, and deposited into irreversible reservoirs 335 as projected constraint artifacts. When contradiction classifications from boundary event classifier 305 accumulate beyond revision threshold Φ_rev, reservoir revision controller 340 initiates localized restructuring of affected consolidated knowledge regions within irreversible reservoirs 335. Downstream of both paths, asymmetric constraint feedback channel 345 provides read-only constraint indices and barrier edge sets from irreversible reservoirs 335 to epistemic admission control subsystem 130 and provides reservoir formation and revision events to manifold evolution and GPU execution subsystem 180, supporting progressive refinement of admission thresholds and geometric evolution of manifold substrate 110 as reservoir structure matures.

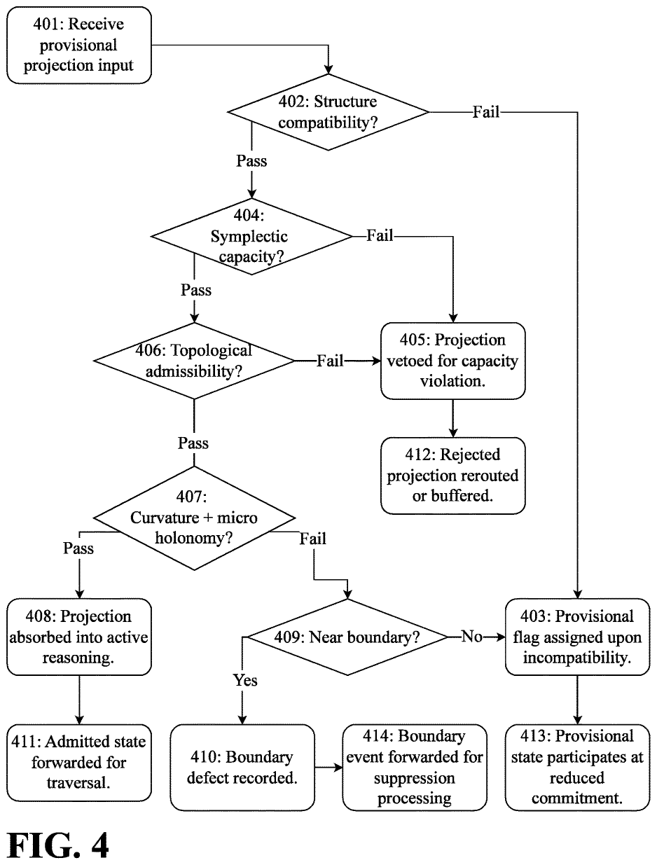

FIG. 4 is a flow diagram illustrating exemplary epistemic admission control evaluation within an epistemically conditioned persistent cognitive system, in an embodiment. Epistemic admission control subsystem 130 receives a provisional projection p₀ from input projection subsystem 120, where p₀ represents a candidate cognitive state mapped to a provisional location on epistemically conditioned manifold substrate 110 via semantic attachment 401. Epistemic admission control subsystem 130 evaluates structural compatibility of an interpolated almost-complex structure at the provisional location by computing a compatibility residual r_J measuring worst-case discrepancy between a transported almost-complex structure at p₀ and existing almost-complex structures at neighboring vertices, and compares the residual against a structural compatibility threshold r_J 402. When the structural compatibility residual exceeds the threshold, epistemic admission control subsystem 130 assigns a flag outcome based on exceeding the structural compatibility threshold and attaches the point as provisional with exclusion from consolidation until local geometry stabilizes 403. When the structural compatibility residual is within threshold, epistemic admission control subsystem 130 evaluates symplectic capacity density by computing a projected post-insertion capacity density [symbol] at the provisional location from local symplectic face areas derived from symplectic form 215 and comparing the density against a capacity density threshold ρ_ω 404. When the projected capacity density exceeds the threshold, epistemic admission control subsystem 130 assigns a veto outcome rejecting the provisional projection from epistemically conditioned manifold substrate 110 405. When the capacity density is within threshold, epistemic admission control subsystem 130 evaluates topological admissibility of the provisional projection within a reservoir-stratified state space defined by removing barrier neighborhoods associated with consolidated regions maintained by consolidation and irreversible suppression subsystem 160, determining whether the provisional insertion and associated immediate transitions are reachable within the accessible region without crossing a barrier boundary absent admission-controlled passage 406. When topological admissibility is not satisfied, epistemic admission control subsystem 130 assigns a veto outcome at the same rejection node as when capacity density exceeds threshold 405. When topological admissibility is satisfied, epistemic admission control subsystem 130 evaluates epistemic curvature by computing insertion curvature F_max over new faces created by the proposed insertion and performing micro-holonomy screening over short closed loops of bounded length L_max passing through p₀ on the discrete cognitive graph, comparing insertion curvature against a curvature threshold F* and loop phase magnitudes against a phase drift threshold Φ*407. When both insertion curvature and micro-holonomy screening are within their respective thresholds, epistemic admission control subsystem 130 assigns an absorb outcome admitting the provisional projection into active reasoning with full geometric assignments on epistemically conditioned manifold substrate 110 408. When insertion curvature exceeds the curvature threshold F* or micro-holonomy screening detects loop phase magnitude exceeding the phase drift threshold Φ*, epistemic admission control subsystem 130 evaluates whether the provisional location is near a reservoir boundary by comparing geodesic distance from p0 to the nearest boundary of a consolidated region maintained by consolidation and irreversible suppression subsystem 160 against a boundary proximity threshold 409. When the provisional location is near a reservoir boundary and insertion curvature exceeds the curvature threshold F* or loop phase magnitude exceeds the phase drift threshold Φ*, epistemic admission control subsystem 130 assigns a defect outcome and records a boundary defect event at the nearest reservoir boundary 410. When the provisional location is not near a reservoir boundary and insertion curvature exceeds the curvature threshold F* or loop phase magnitude exceeds the phase drift threshold Φ*, epistemic admission control subsystem 130 assigns a flag outcome at the same provisional attachment node as when structural compatibility exceeds threshold 403. For absorb outcomes, epistemic admission control subsystem 130 forwards the admitted state with full geometric assignments to traversal and reasoning subsystem 140 for trajectory computation 411. For veto outcomes, the rejected projection is routed to an alternative neighborhood with available capacity or placed in a buffer for deferred integration after a subsequent compression cycle 412. For flag outcomes, the provisionally attached state participates in reasoning at reduced commitment while remaining excluded from consolidation 413. For defect outcomes, the recorded boundary event is forwarded to consolidation and irreversible suppression subsystem 160 for classification by boundary event classifier 305 414.

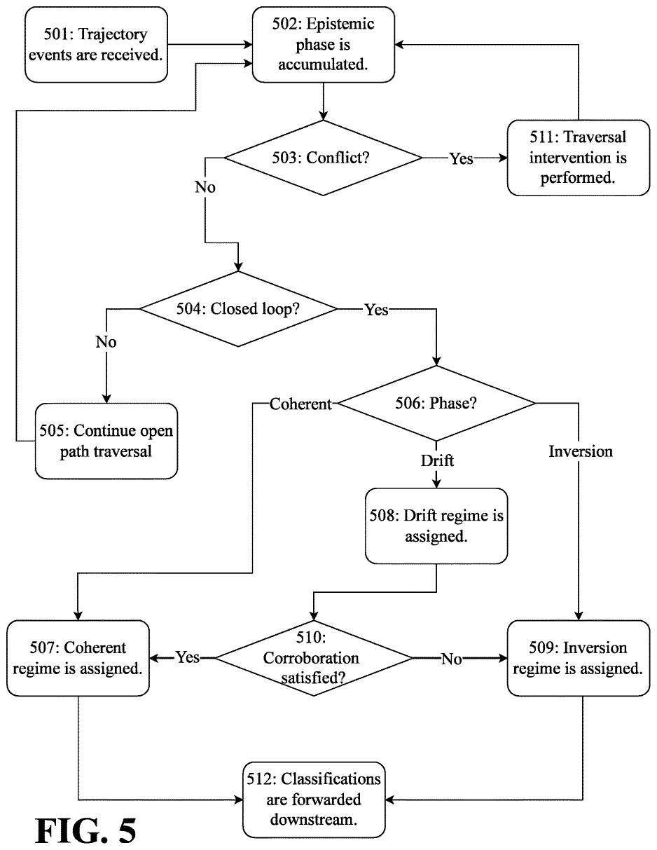

FIG. 5 is a flow diagram illustrating exemplary holonomy and epistemic phase monitoring within an epistemically conditioned persistent cognitive system, in an embodiment. Holonomy and epistemic phase monitoring subsystem 150 receives trajectory events from traversal and reasoning subsystem 140, the trajectory events comprising edge traversals, position updates, and contextual information associated with an active cognitive trajectory, the events being represented as updates to traversal data structures maintained in memory including a current vertex identifier, a visited-vertex index, and an accumulated phase variable 501. Holonomy and epistemic phase monitoring subsystem 150 computes and updates a stored epistemic phase variable Φ along the active trajectory by summing scalar phase values θ assigned by epistemic connection 220 of epistemically conditioned manifold substrate 110 to each edge traversed, the scalar summation being performed over stored edge phase values associated with oriented edges of a discrete cognitive graph, the accumulated phase representing total evidential drift along the reasoning path 502.

Holonomy and epistemic phase monitoring subsystem 150 computes one or more discontinuity metrics to determine whether a phase discontinuity or a conflict among holonomy descriptors applicable to a current traversal location exists, the discontinuity metrics including comparison of incremental phase gradient against a stored gradient threshold, evaluation of compatibility residuals between transported holonomy descriptors exceeding a descriptor conflict threshold, detection of traversal across a homotopy class identifier previously marked as suppressed in a constraint index, or detection of partial loop structures whose accumulated phase magnitude exceeds a bounded pre-closure threshold prior to loop completion 503. When no phase discontinuity metric exceeds its corresponding threshold and no holonomy conflict condition is satisfied, holonomy and epistemic phase monitoring subsystem 150 evaluates whether the active trajectory has revisited a previously visited vertex as determined by a lookup in a visited-vertex hash table maintained in memory, thereby detecting formation of a closed loop 504. When no closed loop is detected, holonomy and epistemic phase monitoring subsystem 150 continues open-path traversal monitoring by maintaining the accumulated phase variable and returns to accumulating epistemic phase along subsequent edges of the active trajectory 505.

When a closed loop γ is detected, holonomy and epistemic phase monitoring subsystem 150 computes a loop-specific epistemic phase Φ(γ) by summing stored edge phase values along the detected loop and classifies the loop into a phase regime by comparing an absolute value of Φ(γ) to a phase drift threshold Φ* and to π, the classification being recorded in a trajectory state structure 506. When the magnitude of Φ(γ) is at or below the phase drift threshold Φ*, holonomy and epistemic phase monitoring subsystem 150 assigns a coherent regime classification indicating that the reasoning loop maintained evidential coherence within tolerance and that consolidation of conclusions drawn along the loop is permitted 507. When the magnitude of Φ(γ) exceeds the phase drift threshold Φ* but remains below π, holonomy and epistemic phase monitoring subsystem 150 assigns a drift regime classification indicating that the loop accumulated significant epistemic drift and that consolidation is deferred pending corroboration by an independent path 508. When the magnitude of Φ(γ) equals or exceeds π, holonomy and epistemic phase monitoring subsystem 150 assigns an inversion regime classification indicating that evidential grounding at the conclusion is misaligned with grounding at the start beyond an inversion threshold, that consolidation is blocked, and that the trajectory is marked for subsequent irreversible suppression by consolidation and irreversible suppression subsystem 160 through setting of a suppression flag in a trajectory control structure 509.

For a trajectory classified in the drift regime, holonomy and epistemic phase monitoring subsystem 150 evaluates whether an independent corroborating path γ′ supplied by traversal and reasoning subsystem 140 satisfies three computationally verifiable conditions: γ′ terminates at a cognitive state whose geodesic distance under semantic metric g is within a proximity threshold of the conclusion reached by the original trajectory; γ′ maintains accumulated epistemic phase within the coherent regime as determined by comparison against phase drift threshold Φ*; and γ′ is not deformable into the original trajectory within the reservoir-stratified state space as determined by comparison of homotopy class identifiers or by evaluating reachability equivalence under barrier edge constraints supplied by consolidation and irreversible suppression subsystem 160 510.

When a phase discontinuity metric exceeds its threshold or a holonomy conflict condition is detected at step 503, holonomy and epistemic phase monitoring subsystem 150 modifies traversal control structures of traversal and reasoning subsystem 140 during reasoning execution, the modification comprising at least one of terminating a traversal stack entry, re-routing traversal through an alternative admissible edge selected from a priority queue excluding edges associated with suppressed homotopy classes or degeneracy regions, performing controlled backtracking to a previously recorded coherent vertex, suspending traversal pending additional input, or marking the trajectory for subsequent irreversible suppression, and after such intervention the redirected or resumed trajectory returns to epistemic phase accumulation with the accumulated phase variable updated in accordance with the modified traversal state 511.

Holonomy and epistemic phase monitoring subsystem 150 forwards phase regime classifications comprising coherent, drift, or inversion designations together with curvature type decomposition into J-invariant and J-anti-invariant components computed from discrete epistemic curvature values associated with faces traversed by the trajectory to consolidation and irreversible suppression subsystem 160, the forwarded data being used for boundary event classification, consolidation gating, and generation of abstract constraint representations for non-invertible projection 512.

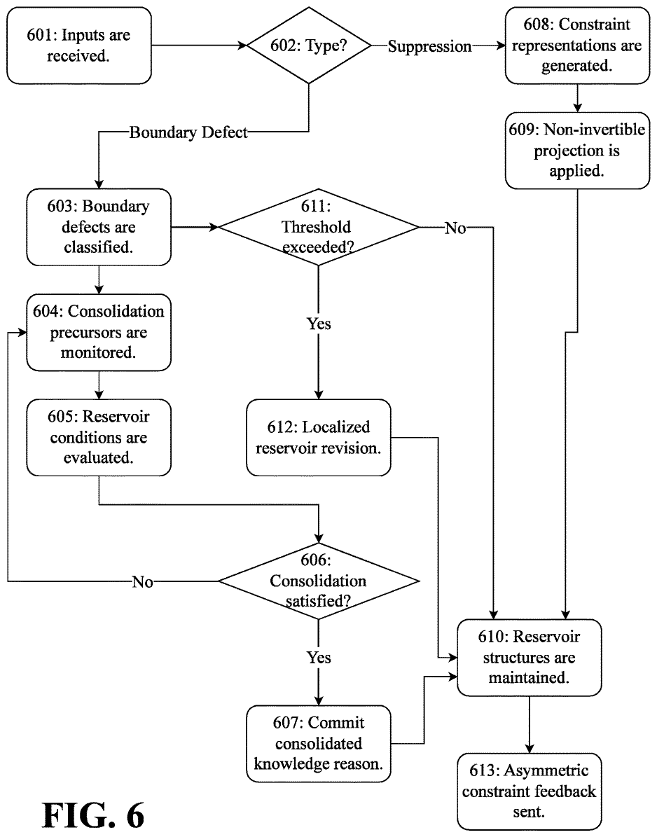

FIG. 6 is a flow diagram illustrating exemplary consolidation and irreversible suppression within an epistemically conditioned persistent cognitive system, in an embodiment. Consolidation and irreversible suppression subsystem 160 receives boundary defect events from epistemic admission control subsystem 130, trajectories marked for suppression from holonomy and epistemic phase monitoring subsystem 150, and current geometric state from epistemically conditioned manifold substrate 110, the received inputs being represented as structured data records stored in memory including defect metrics, trajectory identifiers, and geometric observables 601. Consolidation and irreversible suppression subsystem 160 partitions the received inputs according to event classification, directing boundary defect event records to a consolidation processing stream and directing trajectory records marked for suppression to a suppression processing stream based on stored event-type identifiers 602.

Along the consolidation processing stream, boundary event classifier 305 computes a defect classification for each boundary defect event by comparing phase defect magnitude against a phase defect threshold and by evaluating a curvature type decomposition into J-invariant and J-anti-invariant components received from holonomy and epistemic phase monitoring subsystem 150, assigning each event to one of four stored classification codes corresponding to corroborating evidence B1, novelty B2, contradiction B3, or ambiguous B4 603. When a boundary defect is classified as corroborating evidence B1 or novelty B2, pre-reservoir monitor 310 computes and tracks measurable consolidation precursor metrics in candidate regions approaching reservoir readiness, the metrics including a curvature decay rate computed over successive connection relaxation iterations, a phase coherence variance computed over representative internal loops within a bounded geodesic neighborhood, a barrier energy growth rate computed from stored boundary energy values, and a Nijenhuis tensor magnitude decay computed from structural compatibility residuals, each metric being compared against a corresponding readiness threshold or convergence bound stored in memory 604.

Reservoir formation evaluator 315 evaluates whether a candidate region satisfies three computationally verifiable conditions for recognition as an irreversible reservoir: phase flatness in which stored epistemic curvature magnitudes for all vertices and faces within the region are below flatness threshold ε_R; barrier energy in which boundary energy E∂U computed from curvature magnitude, extrinsic boundary curvature, and symplectic normal variation exceeds barrier threshold E*; and boundary-aware admission control in which admission control outcome codes for new insertions within a boundary neighborhood indicate consistent absorption of compatible states and exclusion of incompatible states according to stored admissibility criteria 605. Consolidation gate 320 computes a logical conjunction of constraint flags corresponding to three layers of the hallucination suppression architecture, requiring (i) epistemic admissibility flag set by epistemic admission control subsystem 130, (ii) epistemic coherence or corroboration flag set by holonomy and epistemic phase monitoring subsystem 150, and (iii) capacity admissibility flag set by reservoir formation evaluator 315, and when the logical conjunction is false consolidation gate 320 returns the candidate region to pre-reservoir monitor 310 for continued precursor monitoring and geometric evolution under relaxation dynamics 606. When the logical conjunction is true, consolidation gate 320 permits the candidate region to transition to an irreversible reservoir within irreversible reservoirs 335 as a consolidated knowledge region, storing region identifiers, boundary indices, and stability metrics reflecting phase flatness, barrier energy, and admission control stability conditions 607.

Along the suppression processing stream, constraint representation generator 325 receives trajectory records marked for suppression and constructs abstract constraint representations by extracting structural violation features from the trajectory record, including violation type, severity indicators derived from phase magnitude or curvature metrics, contextual scope identifiers, and canonical pattern identifiers generated through normalization or hashing procedures supporting recognition of structurally similar patterns in subsequent reasoning 608. Non-invertible projection operator 330 applies a many-to-one canonicalization mapping that discards reconstructable trajectory details including specific manifold coordinates, traversal sequences, and intermediate cognitive state identifiers, while preserving canonical constraint identifiers and structural pattern descriptors, the mapping being implemented such that no inverse mapping from stored constraint representation to original trajectory record exists within active traversal data structures 609.

Irreversible reservoirs 335 maintain both consolidated knowledge regions committed along the consolidation processing stream and projected constraint artifacts deposited along the suppression processing stream, where consolidated knowledge regions are represented as indexed geometric subregions of the manifold satisfying stored phase flatness and barrier energy conditions, and projected constraint artifacts are stored as non-navigable abstract constraint records not reconstructable into executable cognitive trajectories or traversal sequences 610. When a boundary defect is classified as contradiction B3 at step 603, consolidation and irreversible suppression subsystem 160 computes an accumulated contradiction magnitude for the associated boundary region by summing or integrating stored J-anti-invariant curvature magnitudes or phase defect values over successive B3 events within a bounded boundary neighborhood and compares the accumulated magnitude against revision threshold Φ_rev 611. When accumulated contradiction magnitude exceeds revision threshold Φ_rev, reservoir revision controller 340 initiates localized restructuring of an affected consolidated knowledge region within irreversible reservoirs 335, the restructuring being limited to vertices and faces within a bounded geodesic radius of the boundary defect cluster, and comprising localized connection parameter updates, temporary violation of phase flatness constraints, and subsequent re-application of connection relaxation flow to restore curvature below flatness threshold where consistent, such restructuring being confined to the affected region without destabilizing distant reservoir regions 612.

Asymmetric constraint feedback channel 345 exposes read-only constraint indices and barrier edge bitmaps derived from irreversible reservoirs 335 for query by epistemic admission control subsystem 130, enabling admission threshold comparisons and topological admissibility evaluation using updated barrier edge sets, and provides reservoir formation and revision event notifications to manifold evolution and GPU execution subsystem 180 for incorporation into ongoing geometric evolution and threshold recalibration of epistemically conditioned manifold substrate 110, wherein active reasoning processes do not modify contents of irreversible reservoirs through the feedback channel 613.

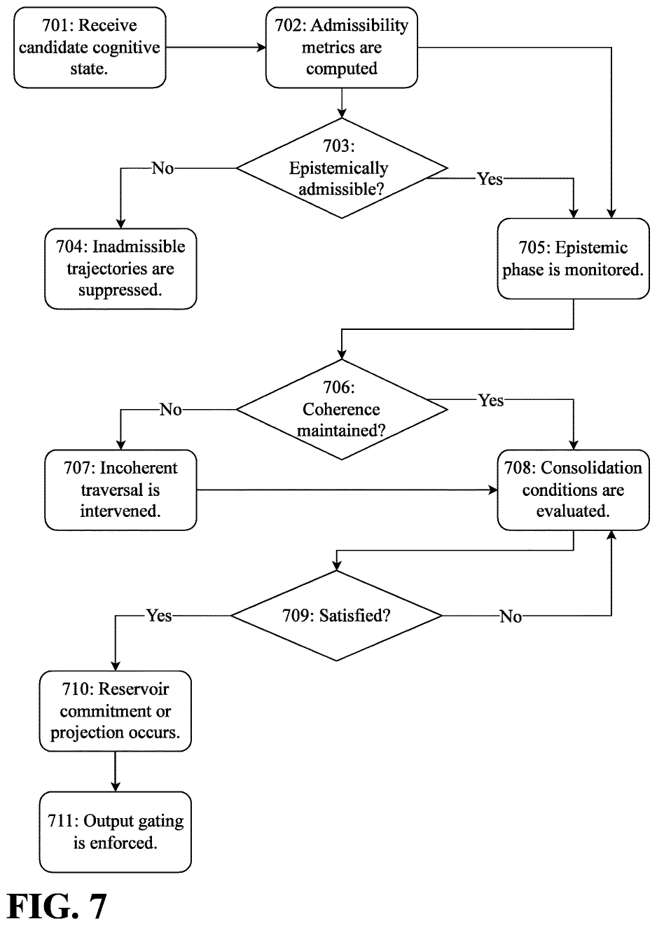

FIG. 7 is a flow diagram illustrating exemplary three-layer hallucination suppression within an epistemically conditioned persistent cognitive system, in an embodiment. A candidate cognitive state enters the three-layer hallucination suppression architecture from input projection subsystem 120 as a provisional projection represented as a candidate vertex and associated geometric attributes stored in memory on epistemically conditioned manifold substrate 110 701. Epistemic admission control subsystem 130 operates as a first layer of the hallucination suppression architecture prior to reasoning execution, computing admissibility metrics for the candidate cognitive state including structural compatibility residuals, projected symplectic capacity density, topological reachability within a reservoir-stratified state space using stored barrier edge bitmaps, and insertion curvature or micro-holonomy values derived from stored edge phase data, and comparing each metric against corresponding stored thresholds maintained on epistemically conditioned manifold substrate 110 702. Epistemic admission control subsystem 130 compares computed admissibility metrics against stored admissibility thresholds and determines whether the candidate cognitive state satisfies epistemic admissibility criteria 703. When epistemic admissibility is not satisfied, epistemic admission control subsystem 130 inhibits instantiation of traversal control structures for the candidate cognitive state, thereby suppressing formation of a reasoning trajectory from the candidate cognitive state and preventing the trajectory from entering active reasoning 704.

When epistemic admissibility is satisfied, the admitted cognitive state is forwarded to holonomy and epistemic phase monitoring subsystem 150, which operates as a second layer of the hallucination suppression architecture during reasoning execution, updating a stored accumulated epistemic phase variable along active trajectories using scalar phase values retrieved from epistemic connection 220 and evaluating phase regime classifications and holonomy descriptor compatibility metrics against stored coherence thresholds 705. Holonomy and epistemic phase monitoring subsystem 150 compares accumulated phase magnitude, descriptor compatibility residuals, and discontinuity metrics against corresponding thresholds to determine whether epistemic coherence is maintained during traversal of the active trajectory, where loss of coherence may arise from phase drift exceeding a phase drift threshold Φ*, a detected phase discontinuity exceeding a discontinuity bound, or conflict among holonomy descriptors indicated by descriptor residuals exceeding a compatibility threshold 706. When epistemic coherence is not maintained, holonomy and epistemic phase monitoring subsystem 150 modifies traversal control structures of traversal and reasoning subsystem 140 by interrupting, redirecting, backtracking, suspending, or marking the trajectory for suppression through setting of stored suppression flags, and the interrupted or marked trajectory is forwarded to consolidation and irreversible suppression subsystem 160 for processing along the suppression path 707.

Consolidation and irreversible suppression subsystem 160 operates as a third layer of the hallucination suppression architecture after detection of epistemic inadmissibility or when an epistemically coherent trajectory satisfies stored consolidation precursor conditions, evaluating reservoir formation criteria and suppression conditions using geometric metrics maintained on epistemically conditioned manifold substrate 110 and constraint indices maintained in irreversible reservoirs 335 708. Consolidation gate 320 of consolidation and irreversible suppression subsystem 160 computes a logical conjunction of stored layer status flags corresponding to epistemic admissibility from the first layer, epistemic coherence or corroboration from the second layer, and capacity admissibility from the third layer, and when the logical conjunction evaluates to false consolidation gate 320 returns the candidate region to continued monitoring within consolidation and irreversible suppression subsystem 160 under geometric evolution and relaxation dynamics 709. When the logical conjunction evaluates to true, consolidation and irreversible suppression subsystem 160 commits a geometrically stable region to irreversible reservoirs 335 as a consolidated knowledge region characterized by stored phase flatness and barrier energy metrics, or projects abstract constraint representations of inadmissible patterns into irreversible reservoirs 335 through non-invertible projection operator 330 according to stored suppression flags and regime classifications 710.

Output generation and expression control subsystem 170 receives stored admissibility status flags from consolidation and irreversible suppression subsystem 160, phase regime classifications from holonomy and epistemic phase monitoring subsystem 150, and trajectory endpoint identifiers from traversal and reasoning subsystem 140, and executes decoding routines only when stored status flags indicate that a reasoning trajectory remained epistemically admissible through all three layers, suppressing, qualifying, or withholding output when no admissible trajectory supports a response 711. Cross-layer interactions are implemented through stored constraint indices and barrier edge sets propagated from consolidation and irreversible suppression subsystem 160 to epistemic admission control subsystem 130, enabling recalculation of admissibility metrics using updated barrier topology and constraint patterns as reservoir structure grows, and through barrier boundary data maintained by epistemic admission control subsystem 130 that restrict the set of topologically admissible corroboration paths evaluated by holonomy and epistemic phase monitoring subsystem 150, such that expansion of reservoir boundaries reduces available homotopy classes and correspondingly increases structural requirements for corroboration as the system matures.

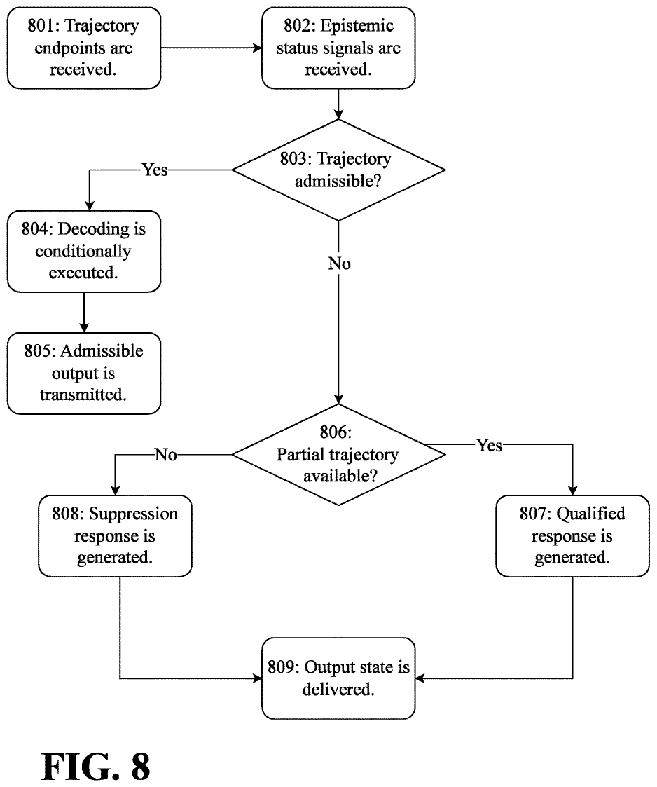

FIG. 8 is a flow diagram illustrating exemplary output generation and expression control within an epistemically conditioned persistent cognitive system, in an embodiment. Output generation and expression control subsystem 170 receives completed trajectory endpoints from traversal and reasoning subsystem 140, the endpoints being represented as trajectory identifiers and associated terminal cognitive state data stored in memory 801. Output generation and expression control subsystem 170 receives epistemic status signals comprising stored phase regime classifications from holonomy and epistemic phase monitoring subsystem 150, consolidation gate decision flags from consolidation and irreversible suppression subsystem 160, and admission outcome flags from epistemic admission control subsystem 130, the signals being maintained as discrete status indicators associated with the completed trajectory 802. Output generation and expression control subsystem 170 computes a final admissibility determination for the completed trajectory by evaluating a logical conjunction of stored status indicators, wherein admissibility requires an absorb outcome at admission, a coherent or corroborated phase regime classification during traversal, and a true consolidation gate flag, and the logical conjunction result is stored as an output eligibility flag 803.

When the output eligibility flag indicates that the trajectory remains epistemically admissible, output generation and expression control subsystem 170 executes a manifold-conditioned decoding routine that maps admissible cognitive states or trajectory results into external representations such as natural language responses, symbolic structures, or executable actions, wherein invocation of the decoding routine is conditioned on the output eligibility flag and decoder-level mechanisms including language models or generation heuristics are executed only when the output eligibility flag is true and are prevented from emitting output when the flag is false 804. Output generation and expression control subsystem 170 transmits the decoded representation corresponding to the admissible trajectory to an external interface or downstream process as system output 805.

When the output eligibility flag indicates that the trajectory does not remain epistemically admissible, output generation and expression control subsystem 170 evaluates whether a stored admissible prefix of the trajectory exists, the prefix corresponding to a portion of the trajectory that maintained coherent or corroborated phase regime status prior to detection of incoherence and being identified using stored phase regime transition points or discontinuity markers 806. When a stored admissible prefix is available, output generation and expression control subsystem 170 generates a qualified or partial response derived solely from cognitive states associated with the admissible prefix, and includes in the response structured indications of epistemic insufficiency corresponding to stored degeneracy region markers, high-curvature regions, barrier boundary encounters, or phase discontinuity locations encountered during traversal 807. When no admissible prefix is available, output generation and expression control subsystem 170 suppresses invocation of the decoding routine and instead generates a suppression response selected from a predefined set including withholding a response, requesting clarification or additional input, or deferring response to a later time or external process, and no decoded content derived from an epistemically inadmissible trajectory is emitted 808. Output generation and expression control subsystem 170 delivers the suppression or qualified response outcome to an external interface or downstream process as a valid system output state, wherein suppression is implemented as a defined architectural state rather than as an error condition 809.

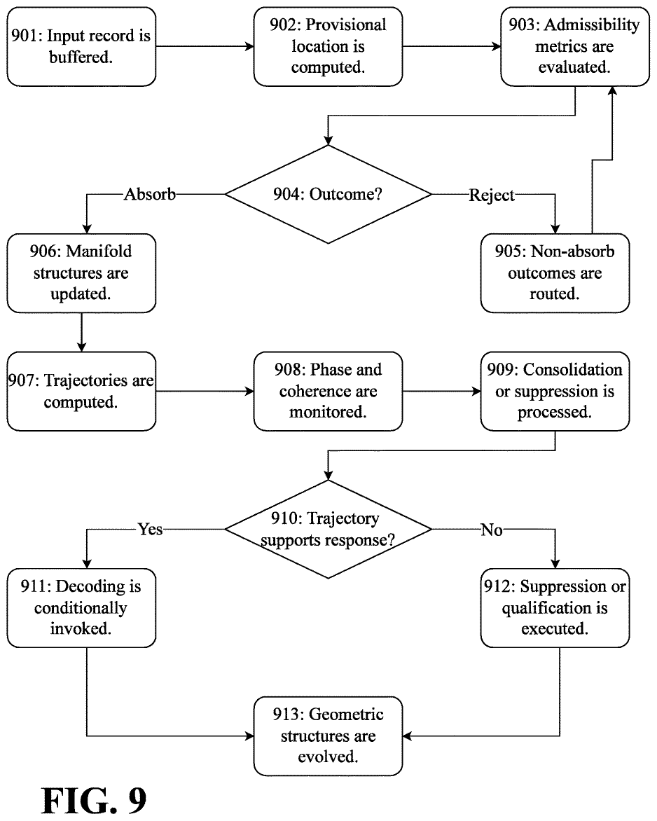

FIG. 9 is a flow diagram illustrating exemplary end-to-end data flow through an epistemically conditioned persistent cognitive system, in an embodiment. An incoming cognitive state from an external input or an internally generated latent representation is written to an input buffer or projection queue of persistent cognitive system 100 and enters a gated processing pipeline as a structured input record 901. Input projection subsystem 120 retrieves the structured input record and maps the incoming cognitive state to a provisional location p0 on epistemically conditioned manifold substrate 110 via semantic attachment, including harmonic extension from nearby landmark states, the provisional location being represented as a candidate vertex with associated geometric attributes and not yet incorporated into active traversal data structures 902.

Epistemic admission control subsystem 130 computes admissibility metrics for the provisional location using geometric state maintained on epistemically conditioned manifold substrate 110, the metrics including structural compatibility residuals of an almost-complex structure, projected symplectic capacity density derived from local symplectic face areas, topological reachability within a reservoir-stratified state space determined from barrier edge bitmaps maintained by consolidation and irreversible suppression subsystem 160, and epistemic curvature metrics computed through insertion curvature and micro-holonomy screening, each metric being compared against corresponding stored thresholds 903. Epistemic admission control subsystem 130 assigns one of a plurality of stored admission outcome codes comprising absorb, veto, flag, or defect based on the threshold comparisons 904.

When the admission outcome code is veto, flag, or defect, epistemic admission control subsystem 130 routes the non-absorbed outcome to an appropriate handling mechanism based on the stored outcome code, wherein a veto outcome routes the rejected projection to an alternative neighborhood selection routine or to a buffer for deferred integration after a subsequent compression cycle, a flag outcome attaches the candidate vertex to epistemically conditioned manifold substrate 110 with a provisional status flag excluding the vertex from consolidation eligibility, and a defect outcome records a boundary event and forwards a boundary defect record to consolidation and irreversible suppression subsystem 160 for classification by boundary event classifier 305 905. When the admission outcome code is absorb, epistemically conditioned manifold substrate 110 updates its stored data structures to include new vertices, edges, faces, interpolated J-structures incorporated into almost-complex structure 210, and edge phases incorporated into epistemic connection 220, and manifold evolution and GPU execution subsystem 180 registers the projection impulse as a discrete perturbation on a fast timescale τ_P 906.

Traversal and reasoning subsystem 140 initializes traversal control structures for the admitted initial state and computes cognitive trajectories through epistemically conditioned manifold substrate 110 subject to admissibility constraints encoded in stored geometric state, including barrier edge checks, capacity density limits, degeneracy region flags, and constraint indices, where trajectories may involve branching, backtracking, or controlled exploration restricted to admissible regions 907. Holonomy and epistemic phase monitoring subsystem 150 updates a stored accumulated epistemic phase variable along active trajectories using transition-specific phase values retrieved from epistemic connection 220, detects phase discontinuities and holonomy descriptor conflicts during open-path traversal by comparing discontinuity metrics and descriptor residuals against thresholds, evaluates loop phase when trajectories revisit previously visited vertices using stored visited-vertex indices, and classifies detected closed reasoning paths into coherent, drift, or inversion phase regimes based on comparison of accumulated phase magnitude against stored thresholds 908.

Consolidation and irreversible suppression subsystem 160 processes trajectories reaching completion or marked for suppression along two parallel processing streams, wherein the consolidation stream evaluates phase flatness, barrier energy, and admission control consistency metrics for candidate regions and applies consolidation gate 320 to compute a logical conjunction of stored epistemic admissibility, epistemic coherence or corroboration, and capacity admissibility flags, and wherein the suppression stream generates abstract constraint representations of inadmissible patterns and applies non-invertible projection operator 330 to store canonical constraint artifacts in irreversible reservoirs 335 909. Output generation and expression control subsystem 170 computes an output eligibility flag for a completed trajectory by evaluating stored admission outcome codes, phase regime classifications, and consolidation gate decisions received from epistemic admission control subsystem 130, holonomy and epistemic phase monitoring subsystem 150, and consolidation and irreversible suppression subsystem 160 respectively 910.

When the output eligibility flag indicates that an admissible trajectory supports a response, output generation and expression control subsystem 170 conditionally invokes a manifold-conditioned decoding routine that maps admissible cognitive states or trajectory results into external representations such as natural language responses, symbolic structures, or executable actions, wherein invocation of decoder-level mechanisms is contingent on the output eligibility flag and decoder routines are prevented from emitting output when the flag is false 911. When the output eligibility flag indicates that no admissible trajectory supports a response, output generation and expression control subsystem 170 executes a suppression or qualification routine selected according to stored suppression codes, wherein suppression may manifest as withholding a response, requesting clarification or additional input, producing a partial or qualified response derived from an admissible trajectory prefix, or deferring response to a later time or external process 912.

Manifold evolution and GPU execution subsystem 180 updates geometric structures of epistemically conditioned manifold substrate 110 asynchronously on separated timescales, wherein a compression flow operating on an intermediate timescale τ_C adjusts manifold coordinates and reduces Nijenhuis tensor magnitude by minimizing an extended geometric energy subject to J-Hermitian compatibility constraints, and a connection relaxation flow operating on a slow timescale τ_R reduces total squared epistemic curvature by updating stored edge phase values, such that updated geometric structures including barrier edge sets, curvature fields, capacity density distributions, and structural compatibility metrics are written to memory and used in subsequent admission, traversal, consolidation, and output evaluations, thereby conditioning subsequent cycles of the gated pipeline against recurrence of previously identified inadmissible reasoning regimes 913.

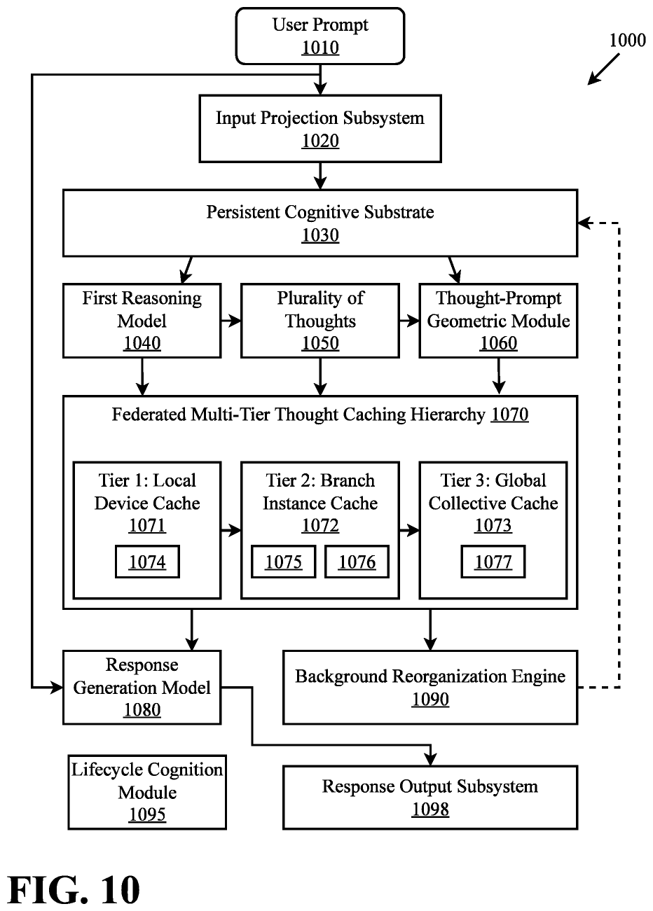

FIG. 10 is a block diagram illustrating an exemplary architecture of a dual large language model processing pipeline and federated multi-tier thought caching hierarchy operating within a persistent cognitive system 1000, according to an embodiment. System 1000 implements the prompt ingestion, thought generation, geometric correspondence, hierarchical caching, and response generation functions of the persistent cognitive system, and coordinates autonomous background reorganization of the persistent cognitive substrate across a federated deployment. The diagram is organized as a vertically layered pipeline representing the persistent cognitive system 1000, with data flowing generally from top to bottom through successively deeper processing stages and with a background reorganization feedback path returning updated substrate state from a cloud execution environment to the persistent cognitive substrate on a separated asynchronous timescale.

A user prompt input 1010 enters the persistent cognitive system 1000 as a structured input record and is received by an input projection subsystem 1020. Input projection subsystem 1020 maps the incoming prompt to a provisional location in a persistent cognitive substrate 1030 through an operational projection that associates input content with regions of an internal configuration space in which cognitive compatibility corresponds to geometric proximity. The provisional location may not be immediately incorporated into active traversal structures but is held pending epistemic admissibility evaluation consistent with admission control mechanisms of the persistent cognitive system.

Persistent cognitive substrate 1030 represents the internal configuration space that serves as the geometric substrate for all cognitive operations of persistent cognitive system 1000. Cognitive states correspond to locations within persistent cognitive substrate 1030 and reasoning processes correspond to trajectories through the substrate geometry. The substrate encodes semantic relationships between cognitive states through geometric proximity such that operationally compatible inputs map to nearby substrate regions, and encodes epistemic conditioning information including capacity constraints, admissibility boundaries, and path-dependent descriptors that govern which reasoning trajectories may be formed and traversed. Persistent cognitive substrate 1030 receives projection events from input projection subsystem 1020 on a fast timescale, receives geometric evolution updates from a manifold evolution subsystem on intermediate and slow timescales, and provides current geometric state to all downstream processing stages of the pipeline.

A first reasoning model 1040, which may be implemented using one or more large language models, receives the projected prompt state from persistent cognitive substrate 1030 and processes the prompt into a plurality of corresponding thoughts 1050 represented as a structured set {T₁, T₂, . . . Tₙ} . First reasoning large language model 1040 may be implemented as a high-parameter reasoning model configured to perform extended chain-of-thought decomposition, and each thought produced by first reasoning large language model 1040 corresponds to a structured region within persistent cognitive substrate 1030 such that the geometric location of a thought within the substrate encodes its semantic and epistemic relationships to other cognitive states. Plurality of thoughts 1050 is forwarded to a thought-prompt geometric correspondence module 1060, which associates each thought in plurality of thoughts 1050 to a portion of the original prompt through geometric correspondence within persistent cognitive substrate 1030. Thought-prompt geometric correspondence module 1060 computes association weights reflecting the degree of geometric alignment between a thought region and a prompt region within the substrate, thereby grounding the correspondence in structural substrate geometry rather than in surface lexical similarity alone.

A federated multi-tier thought caching hierarchy 1070 receives associated thoughts from thought-prompt geometric correspondence module 1060 and organizes them across three hierarchical storage tiers operating as a holonomy-based constraint memory. Federated multi-tier thought caching hierarchy 1070 is designed so that repeated or compatible thoughts are compressed into shared geometric structure across tiers, such that representational complexity of the hierarchy grows sublinearly with accumulated experience. The three tiers of federated multi-tier thought caching hierarchy 1070 are a local device cache 1071, a domain-specific branch instance cache 1072, and a global collective cache 1073, each maintaining distinct scope, compression level, and access characteristics. Thoughts are promoted from lower tiers to higher tiers through non-invertible holonomy compression in which path-specific details are compressed into transport equivalence classes at each promotion stage and information specific to the originating scope is irreversibly removed, so that higher-tier representations encode structural constraint patterns abstractable across multiple originating experiences without retaining reconstructable details of any individual thought trajectory.

Local device cache 1071 constitutes the first tier of federated multi-tier thought caching hierarchy 1070 and stores path-specific thought representations at the granularity of individual reasoning trajectories, together with fast-access local holonomy state and session-scoped geometric structure reflecting the current interaction context. Local device cache 1071 supports battery-aware processing control 1074, which dynamically adjusts the depth and scope of substrate operations performed during thought retrieval and storage based on device power state. When device power state indicates constrained resources, battery-aware processing control 1074 reduces traversal depth and restricts access to local cache contents, deferring operations that require access to higher cache tiers or background reorganization resources until power state permits fuller execution.

According to the embodiment, domain-specific branch instance cache 1072 constitutes the second tier of federated multi-tier thought caching hierarchy 1070 and maintains domain-specific holonomy compression of thoughts promoted from local device cache 1071. Promotion from local device cache 1071 to domain-specific branch instance cache 1072 applies a non-invertible stage compression 1075 that maps path-specific thought representations to transport equivalence classes encoding holonomy signatures abstractable across sessions originating within a common domain, while discarding session-specific geometric coordinates and traversal sequences. Domain-specific branch instance cache 1072 further implements bandwidth-adaptive federated synchronization 1076, which adjusts the granularity and frequency of structural exchange between federated instances based on available network bandwidth, ensuring that synchronization cost scales as a function of compressed geometric structure rather than as a function of total accumulated experience.

According to the embodiment, global collective cache 1073 constitutes the third and highest tier of federated multi-tier thought caching hierarchy 1070 and maintains shared geometric structure aggregated from domain-specific branch instance cache 1072 contributions across all federated instances. Global collective cache 1073 stores cross-domain holonomy aggregates representing constraint patterns whose structural validity has been corroborated across multiple domain-specialized instances. Global collective cache 1073 implements privacy-preserving structural exchange 1077 through multi-stage anonymization that progressively removes personally identifiable information from thought patterns while preserving geometric structure including trajectory class, holonomy signature, and homotopy membership. Anonymization in privacy-preserving structural exchange 1077 is completed through non-invertible projection into a residual sector from which original thought content cannot be reconstructed, ensuring that cross-domain knowledge sharing does not expose source-domain cognitive content while preserving structural constraint information usable for admission control and traversal guidance in receiving instances.

A response generation model 1080, which may be implemented as a second large language model, receives both the original (or in some instances, copies thereof) prompt from input projection subsystem 1020 and the plurality of thoughts 1050 retrieved or cached within federated multi-tier thought caching hierarchy 1070 and processes them together to generate a response. Second large language model 1080 has fewer parameters than first reasoning large language model 1040 and is configured as a response generation model that routes the combined prompt and thought inputs through its processing architecture to produce a decoded output. The routing of both prompt and thoughts through second large language model 1080 enables the response generation stage to condition its output on the structured decomposition produced by first reasoning large language model 1040 while operating at reduced computational cost relative to the full reasoning model. Output from second large language model 1080 is directed to a response output subsystem 1098 which delivers a decoded representation to an external interface or downstream process, wherein the response may be a full response, a qualified response, or a suppressed response depending on the epistemic admissibility status of the reasoning trajectory that produced it.

A background reorganization engine 1090 operates in a cloud environment and performs autonomous reorganization of persistent cognitive substrate 1030 without requiring user interaction. Background reorganization engine 1090 receives substrate state from global collective cache 1073 and executes three categories of reorganization operation: perturbation and recombination of existing substrate structure to explore alternative geometric configurations; merging of compatible structures into higher-level abstractions through holonomy compression that reduces representational redundancy; and pruning of unused or inadmissible structure through residual export that projects constraint representations of irreconcilable patterns into a non-navigable residual sector from which they cannot be reconstructed. Background reorganization engine 1090 provides updated substrate state back to persistent cognitive substrate 1030 through an asynchronous feedback path depicted as a dashed line, reflecting that background reorganization operates on a slow timescale decoupled from the fast-timescale projection and intermediate-timescale compression flows governing active reasoning. This timescale separation ensures that background reorganization does not interfere with active reasoning operations while progressively refining the geometric structure of the substrate between interactions.

A lifecycle of cognition module 1095 records and tracks the sequential phases through which cognitive content passes within persistent cognitive system 1000. The lifecycle comprises five phases: encounter and projection of input into persistent cognitive substrate 1030 through input projection subsystem 1020; traversal and use of cached thoughts along paths shaped by prior learning as reflected in the geometric structure of federated multi-tier thought caching hierarchy 1070; constraint accumulation manifesting as geometric strain at domain boundaries when new content conflicts with consolidated substrate regions; consolidation through reuse that compresses and stabilizes substrate regions satisfying phase flatness and barrier energy conditions; and background reorganization through background reorganization engine 1090 that smooths geometric irregularities and merges compatible structures on a slow asynchronous timescale. Lifecycle of cognition module 1095 provides status information to output generation routines to condition the character of responses on the current lifecycle phase of the relevant substrate regions.

According to an embodiment, the effective memory of the system grows sublinearly as O(log E) with cumulative experience E through holonomy-based compression within federated multi-tier thought caching hierarchy 1070, such that the representational cost of maintaining cached thought content increases at a rate substantially below linear growth in the number of accumulated experiences. Marginal computational cost decreases over time through variational stabilization of frequently used reasoning trajectories, wherein an action functional over trajectory space within persistent cognitive substrate 1030 is deformed by experience such that successful reasoning patterns are reinforced through reduced traversal cost and unsuccessful reasoning patterns are suppressed through increased curvature resistance, so that the per-query cost of executing a mature reasoning trajectory is lower than the cost of executing a novel trajectory of comparable length. Coordination cost across federated instances is absorbed into the geometric structure of persistent cognitive substrate 1030 through the holonomy compression and structural exchange mechanisms of federated multi-tier thought caching hierarchy 1070 rather than expressed as inter-agent communication overhead scaling with agent count, such that the marginal coordination cost of adding a federated instance decreases as shared geometric structure matures.

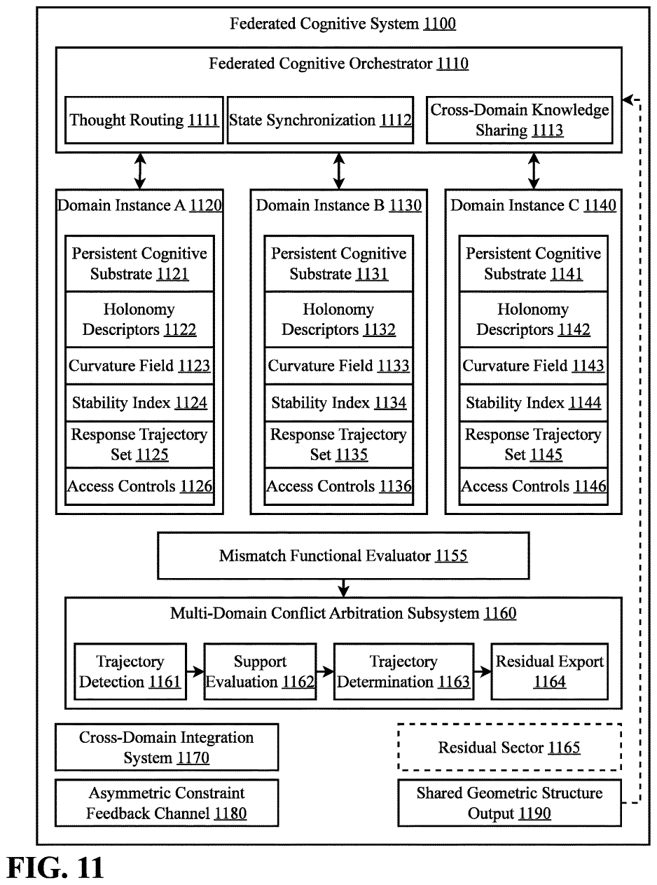

FIG. 11 is a block diagram illustrating an exemplary architecture of a federated cognitive orchestrator and multi-domain conflict arbitration subsystem within a federated cognitive system 1100, according to an embodiment. The architecture 1100 implements the coordination, domain separation, sectorized interface management, and conflict arbitration functions of the persistent cognitive system across multiple domain-specialized instances, each maintaining an independent persistent cognitive substrate conditioned by domain-specific geometric structure. The diagram is organized as a vertically layered architecture within an outer boundary representing federated cognitive system 1100, with a federated cognitive orchestrator 1110 positioned at the top of the architecture coordinating all inter-instance operations, three domain-specialized instances arranged horizontally below the orchestrator, a mismatch functional evaluator and multi-domain conflict arbitration subsystem occupying an intermediate layer, and cross-domain integration, residual sector, constraint feedback, and shared geometric structure output components forming the lower layers of the architecture.

Federated cognitive orchestrator 1110 is the central coordination component of federated cognitive system 1100 and implements various primary inter-instance management functions including, but not limited to: thought routing 1111, state synchronization 1112, and cross-domain knowledge sharing 1113. Thought routing 1111 directs incoming prompts and their associated thought sets to the domain-specialized instance or set of instances whose persistent cognitive substrate geometry is most compatible with the projected input, evaluated through geometric proximity within each instance's configuration space. State synchronization 1112 maintains coherent geometric state representations across federated instances by propagating updates to holonomy descriptors, curvature fields, and barrier edge sets through structured synchronization events coordinated on a timescale consistent with intermediate-speed geometric evolution of the substrate. Cross-domain knowledge sharing 1113 permits federated cognitive orchestrator 1110 to transfer structural knowledge across domain boundaries subject to the constraints imposed by graduated access controls within each domain-specialized instance, ensuring that inter-domain knowledge transfer is governed by geometric admissibility rather than unrestricted exchange.

Three domain-specialized instances, domain instance A 1120, domain instance B 1130, and domain instance C 1140, are depicted as structurally parallel components each maintaining an independent persistent cognitive substrate conditioned by domain-specific geometric state. Domain instance A 1120 comprises a persistent cognitive substrate 1121 organized as a domain-A configuration space, together with holonomy descriptors 1122, a domain-specific curvature field 1123, a homotopy stability index 1124, a response trajectory set {R₁} 1125, and graduated access controls 1126. Domain instance B 1130 maintains corresponding components 1131, 1132, 1133, 1134, 1135, 1136 organized as a domain-B configuration space. Domain instance C 1140 maintains corresponding components 1141, 1142, 1143, 1144, 1145, 1146 organized as a domain-C configuration space. In each instance, holonomy descriptors encode path-dependent transport properties of the domain configuration space accumulated through prior reasoning traversals, the domain-specific curvature field encodes local epistemic strain derived from the epistemic connection of the persistent cognitive substrate, and the homotopy stability index records the degree to which established homotopy classes of reasoning trajectories within the domain have been corroborated through repeated compatible traversal. Each instance maintains a set of graduated access controls 1126, 1136, 1146 that govern the conditions under which structural information from the instance may be shared with federated cognitive orchestrator 1110 for redistribution to other instances, ensuring that domain separation is maintained at the level of geometric structure rather than merely at the level of output filtering.

Each domain-specialized instance may comprise a region at its boundary designated as a non-commuting projection region. Non-commuting projection regions correspond to areas of the persistent cognitive substrate where the application of operational projections associated with different domain instances does not commute, such that the order in which domain-specific projection operations are applied to a shared input determines distinct outcomes in distinct instances. This non-commutativity is the geometric basis for domain boundary management within federated cognitive system 1100 and is the structural property that necessitates the sectorized interface management implemented by federated cognitive orchestrator 1110. Two sector boundaries exist between adjacent domain-specialized instances: sector boundary A-B positioned between domain instance A 1120 and domain instance B 1130, and sector boundary B-C positioned between domain instance B 1130 and domain instance C 1140. Sector boundaries and represent the regions of the substrate configuration space in which the non-commutativity of domain projections is most pronounced and in which cross-domain knowledge transfer requires the most stringent admissibility evaluation.

A mismatch functional evaluator 1155 receives geometric representations from sector boundary A-B and sector boundary B-C and computes a scalar mismatch functional quantifying the degree of incompatibility between the domain representations meeting at each sector boundary. The mismatch functional is derived from geometric quantities including the geodesic distance between corresponding substrate regions of adjacent instances, the difference in accumulated holonomy between the respective domain curvature fields at the boundary, and the divergence between the homotopy stability indices of the adjacent domains in the boundary neighborhood. Mismatch functional evaluator 1155 implements a threshold-based routing decision: when the computed mismatch at a sector boundary falls below an absorption threshold, the cross-domain knowledge transfer is routed through the cross-domain integration framework 1170 for structural absorption into the receiving instance's substrate; when the computed mismatch exceeds the absorption threshold, the excess mismatch is routed to the residual sector 1165 through a non-invertible projection that discards content-specific information while recording the structural incompatibility as a constraint pattern. This dual-path routing ensures that cross-domain conflicts that cannot be absorbed into active substrate structure do not contaminate domain-specific geometric state and do not produce oscillatory reasoning failures of the type that arise when irreconcilable constraints are permitted to cycle between active reasoning structures.

A multi-domain conflict arbitration subsystem 1160 receives conflict notifications from mismatch functional evaluator 1155 and from domain-specialized instances when divergent response trajectories are detected, and coordinates resolution of those conflicts through a four-step sequential arbitration flow. The multi-domain conflict arbitration subsystem 1160 operates on geometric representations of reasoning trajectories within the persistent cognitive substrate and resolves conflicts at the level of substrate structure rather than at the level of decoded output, ensuring that resolved conflict patterns are incorporated into the geometric state governing future reasoning operations rather than merely filtered from individual responses.

The multi-step arbitration flow implemented by multi-domain conflict arbitration subsystem 1160 proceeds as follows. In Step 1, divergent trajectory detection 1161 evaluates the geometric distance between response trajectory sets produced by different domain-specialized instances in response to a common or related input, computing pairwise geodesic distances between response trajectories within the persistent cognitive substrate and flagging pairs of trajectories whose geometric distance exceeds a divergence threshold as candidates for arbitration. In Step 2, structural support evaluation 1162 assesses the evidentiary basis of each divergent trajectory by computing three geometric quantities for each trajectory: domain-specific curvature reflecting the local epistemic strain associated with the trajectory's path through its originating instance's substrate; holonomy weight reflecting the accumulated path-dependent transport magnitude of the trajectory, which provides a measure of how far the trajectory has departed from a flat reference geometry; and homotopy stability reflecting the stability index of the homotopy class to which the trajectory belongs, which indicates whether the trajectory class has been repeatedly corroborated through compatible traversal or represents a novel and structurally fragile path. In Step 3, consensus trajectory determination 1163 evaluates whether a geometric consensus trajectory exists that is reachable from each of the conflicting trajectories through admissible deformation within the persistent cognitive substrate, determining reachability by testing whether a continuous deformation path connecting each conflicting trajectory to a proposed consensus trajectory remains within the admissibility boundary of the substrate and does not cross barrier edges associated with consolidated reservoir regions. When a reachable consensus trajectory is identified, the consensus trajectory is adopted as the resolved output trajectory and is distributed to the relevant domain-specialized instances through cross-domain integration framework 1170. In Step 4, non-invertible residual export 1164 handles conflicts for which no reachable consensus trajectory exists by projecting the irreconcilable conflict into residual sector 1165 through a non-invertible many-to-one mapping that discards reconstructable trajectory details while preserving canonical constraint identifiers encoding the structural character of the conflict. Irreconcilable conflicts deposited in residual sector 1165 accumulate monotonically and cannot be reconstructed into executable reasoning trajectories, ensuring that the arbitration record enforces progressive constraint tightening rather than permitting repeated revisitation of structurally irreconcilable reasoning patterns.

A cross-domain integration framework 1170 receives consensus trajectories from Step 3 of the arbitration flow and manages the structural absorption of cross-domain knowledge into the relevant domain-specialized instances. Cross-domain integration framework 1170 implements three categories of inter-domain operation: knowledge transfer, in which structural features of a consensus trajectory are mapped into the receiving instance's substrate through a projection that preserves holonomy class and homotopy membership while adapting coordinate representations to the receiving domain's configuration space; structural absorption, in which transferred knowledge is integrated into the receiving instance's persistent cognitive substrate through a geometric deformation that respects existing capacity constraints, admissibility boundaries, and barrier energy conditions of the receiving domain; and domain boundary management, in which the integration event is recorded as a cross-domain transfer that updates the mismatch functional evaluator's reference state for the affected sector boundary to reflect the post-integration geometric configuration. Output from cross-domain integration framework 1170 feeds into an asymmetric constraint feedback channel 1180 which propagates updated constraint information back to the domain-specialized instances.

Residual sector 1165 is a non-navigable, non-reconstructable region of the persistent cognitive substrate into which irreconcilable semantic conflicts are exported through non-invertible residual export 1164 and into which excess mismatch is deposited by mismatch functional evaluator 1155 when mismatch exceeds the absorption threshold. Residual sector 1165 is depicted in FIG. 11 with a dashed boundary reflecting its non-active status with respect to reasoning traversal. Content deposited in residual sector 1165 accumulates monotonically through the irreversibility of the projection operations that deposit it, and active reasoning processes do not modify residual sector contents through ordinary traversal or decoding mechanisms. The monotonic constraint accumulation property of residual sector 1165 ensures that the system's record of structurally irreconcilable cross-domain conflicts only grows over time, progressively tightening the admissibility constraints that govern future cross-domain reasoning operations and preventing oscillatory reasoning failures in which the same conflict is re-encountered and re-processed without structural resolution.

An asymmetric constraint feedback channel 1180 provides read-only access to updated constraint indices, barrier edge sets, and admission threshold parameters derived from cross-domain integration framework 1170 and residual sector 1165 for consumption by the domain-specialized instances. The read-only character of asymmetric constraint feedback channel 1180 ensures that active reasoning processes within domain-specialized instances may consult accumulated cross-domain constraint information to inform admission control and traversal decisions without being able to modify the constraint record itself, thereby preserving the monotonic constraint accumulation property of both residual sector 1165 and the broader federated constraint architecture. A shared geometric structure output 1190 distributes updated synchronized holonomy signatures, revised curvature fields, and updated barrier edge sets derived from resolved cross-domain integration events to all federated instances coordinated by federated cognitive orchestrator 1110. Shared geometric structure output 1190 also provides structural update signals to federated cognitive orchestrator 1110 through a dashed feedback path, reflecting that orchestrator state is updated asynchronously on a timescale consistent with completed integration events rather than on the fast timescale of individual reasoning traversals. The combination of asymmetric constraint feedback channel 1180 and shared geometric structure output 1190 closes the coordination loop of federated cognitive system 1100 in a manner that ensures progressive geometric maturation of all domain-specialized instances through shared constraint experience while preserving domain separation through the graduated access controls and non-invertible conflict projection mechanisms of the architecture.

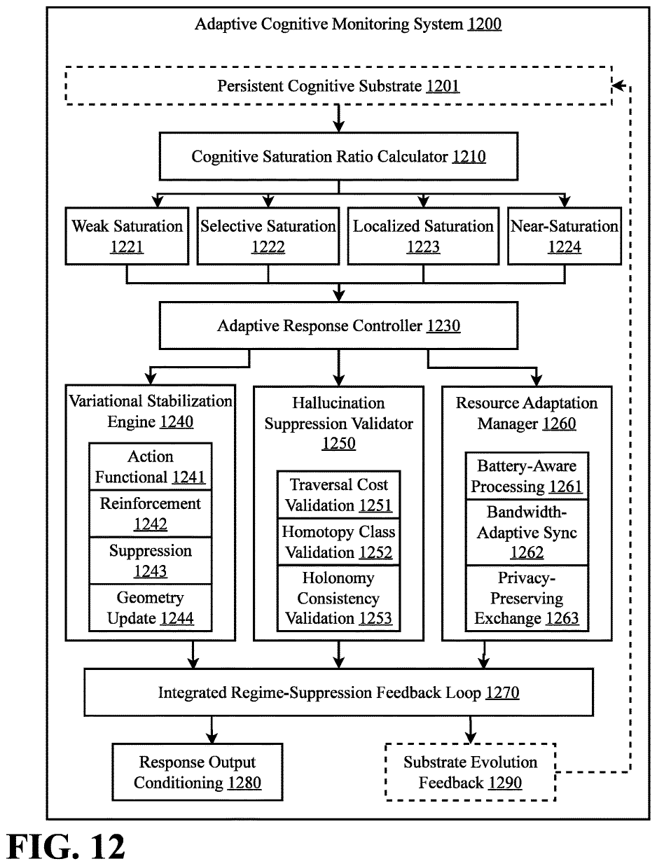

FIG. 12 is a block diagram illustrating an exemplary architecture of a cognitive regime monitoring system, variational stabilization engine, hallucination suppression validator, and resource adaptation manager integrated within an adaptive cognitive monitoring system 1200, according to an embodiment. The architecture depicted in FIG. 12 implements the dynamic operational layer of the persistent cognitive system, governing how system behavior adapts in response to evolving geometric state within persistent cognitive substrate 1201 and how that adaptive behavior feeds back to modulate the geometry of the substrate over time. The diagram is organized as a vertically layered architecture within an outer boundary representing adaptive cognitive monitoring system 1200, with persistent cognitive substrate 1201 providing observable quantities at the top, a cognitive saturation ratio calculator 1210 occupying a second layer, four cognitive regime boxes spanning a third layer, an adaptive response controller 1230 receiving regime outputs in a fourth layer, three parallel functional columns implementing variational stabilization, hallucination suppression validation, and resource adaptation in a fifth layer, an integrated regime-suppression feedback loop 1270 collecting outputs from all three columns in a sixth layer, and response output conditioning 1280 and substrate evolution feedback 1290 forming the lowest layer of the architecture, with bidirectional dashed feedback paths returning updated geometric state to persistent cognitive substrate 1201 and returning suppression outcomes to the regime monitoring layer.

Persistent cognitive substrate 1201 serves as the primary observable source for adaptive cognitive monitoring system 1200 and provides various categories of geometric quantity to downstream processing stages including, but not limited to: mismatch intensity, reflecting the magnitude of structural incompatibility between incoming cognitive content and consolidated substrate regions; adaptive capacity, reflecting the available representational and traversal resources within the substrate at the time of monitoring; epistemic curvature, reflecting the distribution of curvature derived from the epistemic connection across active substrate regions; holonomy descriptors, reflecting path-dependent transport properties accumulated through prior reasoning traversals; and trajectory records, reflecting the geometric characteristics of recently executed reasoning trajectories including their traversal cost, homotopy class membership, and loop holonomy magnitudes. These five observable quantities collectively characterize the epistemic state of the substrate at each monitoring interval and provide the inputs necessary for cognitive saturation ratio calculation, regime classification, and adaptive control.

A cognitive saturation ratio calculator 1210 receives mismatch intensity and adaptive capacity from persistent cognitive substrate 1201 and computes a cognitive saturation ratio as the quotient of mismatch intensity divided by adaptive capacity. The cognitive saturation ratio is a dimensionless scalar that measures the relationship between the structural strain currently being imposed on the substrate by incoming or active cognitive content and the residual geometric capacity of the substrate to absorb and represent that content without violating admissibility constraints. A low cognitive saturation ratio indicates that mismatch intensity is small relative to available adaptive capacity, reflecting a substrate in a geometrically uncongested state where new content can be readily projected and traversed. A high cognitive saturation ratio indicates that mismatch intensity is approaching or exceeding adaptive capacity, reflecting a substrate in a geometrically stressed state where continued processing at full depth would risk violating capacity constraints, admissibility boundaries, or barrier energy conditions of consolidated substrate regions. The cognitive saturation ratio computed by cognitive saturation ratio calculator 1210 is forwarded to a regime classification stage that assigns the current system state to one of four operational regimes based on the ratio value and its recent trajectory.

The regime classification stage identifies four operational regimes based on the output of cognitive saturation ratio calculator 1210, each regime corresponding to a distinct range of saturation ratio values and a corresponding set of recommended adaptive adjustments. Regime I, weak saturation 1221, corresponds to a low saturation ratio and is characterized by cache-dominated processing in which the federated multi-tier thought caching hierarchy satisfies the majority of reasoning requests from cached geometric structure without requiring full-depth substrate traversal, with background reorganization active and full-depth traversal operations enabled for novel content that cannot be resolved from cache. Regime II, selective saturation 1222, corresponds to a moderate saturation ratio and is characterized by narrowed trajectory admissibility in which the range of substrate trajectories that pass admission control is tightened relative to the Regime I baseline, together with reduced processing depth limiting the extent of substrate traversal executed per query and selective model engagement restricting which processing stages are invoked based on estimated traversal cost. Regime III, localized saturation 1223, corresponds to an elevated saturation ratio and is characterized by explicit uncertainty signaling in which responses are accompanied by structured epistemic qualifications reflecting the elevated mismatch state of the substrate, deferred judgment mode in which conclusions that would require traversal through high-curvature substrate regions are deferred pending geometric relaxation, and constrained resource allocation limiting concurrent background processing operations. Regime IV, distributed near-saturation 1224, corresponds to a high saturation ratio approaching the limit of available adaptive capacity and is characterized by activation of background reorganization as a priority operation, enabling perturbation and merging of substrate structure to reduce accumulated mismatch, together with battery-aware and bandwidth-adaptive processing adjustments that further constrain foreground operations to preserve essential state across all execution profiles. It should be appreciated that regime transitions are reversible: the system transitions upward from lower to higher regimes as the saturation ratio increases and downward as background reorganization and geometric relaxation reduce accumulated mismatch and restore adaptive capacity.

An adaptive response controller 1230 receives regime classification signals from all four operational regimes and translates them into three categories of adaptive adjustment that are distributed to the downstream functional columns of adaptive cognitive monitoring system 1200. The three adjustment categories are processing depth, which governs the maximum extent of substrate traversal operations permitted during a reasoning cycle; model selection, which governs which computational resources and model configurations are engaged for thought generation and response production; and resource allocation, which governs the distribution of available memory, compute, and synchronization bandwidth across foreground reasoning, background reorganization, and federated synchronization operations. Adaptive response controller 1230 applies regime-specific parameter tables that map each regime classification to a corresponding set of threshold values, depth limits, and resource budgets, and forwards the resulting adjustment signals to variational stabilization engine 1240, hallucination suppression validator 1250, and resource adaptation manager 1260 as concurrent control inputs that modulate the operation of each functional column in proportion to the current regime state.

Variational stabilization engine 1240 implements experience-driven deformation of an action functional 1241 defined over the trajectory space of persistent cognitive substrate 1201 such that the geometric cost of executing a reasoning trajectory is progressively modified by the history of prior traversals along that trajectory or structurally related trajectories. Action functional 1241 assigns a scalar traversal cost S[γ] to each trajectory γ through the substrate, computed as an integral of local geometric cost contributions along the trajectory path including epistemic curvature, semantic metric length, and barrier proximity. Variational stabilization engine 1240 updates action functional 1241 through two complementary adjustment mechanisms that operate in parallel. A reinforcement path 1242 processes records of successful reasoning trajectories, defined as trajectories that passed epistemic admissibility evaluation, maintained coherence through holonomy and phase monitoring, and produced outputs that were not flagged for suppression or qualification, and applies a reduction to the traversal cost assigned to those trajectories by action functional 1241, so that future executions of the same or geometrically similar trajectories require lower computational cost than their first traversal. A suppression path 1243 processes records of unsuccessful reasoning trajectories, defined as trajectories that were flagged by epistemic admission control, interrupted by holonomy monitoring, or suppressed by the hallucination suppression validator, and applies an increase to the local curvature resistance assigned to the substrate regions traversed by those trajectories, so that future attempts to execute trajectories through the same substrate regions encounter elevated geometric resistance that discourages traversal without formally prohibiting it. The net effect of the concurrent operation of reinforcement path 1242 and suppression path 1243 is a substrate geometry update 1244 in which the action functional over trajectory space is continuously deformed by accumulated experience such that mature frequently-used reasoning trajectories exhibit sublinear marginal cost and structurally unsuccessful trajectory classes accumulate curvature resistance proportional to their failure history. This deformation implements variational stabilization as an architectural property of the substrate geometry rather than as a post hoc weighting of outputs, and produces the marginal cost decrease with experience that contributes to the sublinear computational scaling properties of the persistent cognitive system.

A hallucination suppression validator 1250 implements geometric structural validation of response trajectories through three sequential validation checks applied to each candidate response trajectory prior to output generation. The three checks are applied in series and a trajectory must pass all applied checks to proceed to the response output conditioning stage without suppression or qualification. Traversal cost validation 1251 evaluates the total traversal cost assigned to the candidate response trajectory by action functional 1241 and flags any trajectory whose cost requires traversal through high-cost regions of persistent cognitive substrate 1201, reflecting that high-cost substrate regions correspond to geometrically stressed areas of elevated epistemic curvature or proximity to barrier boundaries where reasoning reliability is reduced. Homotopy class validation 1252 evaluates whether the candidate response trajectory belongs to an established homotopy class within the reservoir-stratified state space of persistent cognitive substrate 1201, where established homotopy classes are those that have been corroborated through repeated compatible traversal and recorded in the holonomy descriptors of the federated multi-tier thought caching hierarchy, and flags any trajectory that does not belong to an established class as structurally novel and potentially unreliable. Holonomy consistency validation 1253 evaluates the loop holonomy of the candidate response trajectory and compares it against accumulated holonomy records stored in the relevant tier of the federated multi-tier thought caching hierarchy, flagging any trajectory whose loop holonomy magnitude is inconsistent with the accumulated holonomy in the applicable cache tier beyond a stored consistency threshold. Trajectories passing all three validation checks are forwarded with an admit signal to response output conditioning 1280; trajectories failing one or more checks are forwarded with a suppress or qualify signal that conditions the character of the output accordingly.

A resource adaptation manager 1260 receives processing depth, model selection, and resource allocation adjustment signals from adaptive response controller 1230 and implements three categories of regime-responsive resource management. Battery-aware processing 1261 dynamically adjusts the depth and scope of substrate operations based on device power state, implementing a set of execution profiles that range from full-depth traversal with active background reorganization at the high-power end to local-cache-only operation with essential state preservation at the constrained-power end, with intermediate profiles engaging progressively reduced substrate traversal depth and background processing intensity as device power state constrains available compute. Bandwidth-adaptive synchronization 1262 adjusts the granularity and frequency of structural exchange between federated instances of the persistent cognitive system based on available network bandwidth, exchanging compressed geometric structure derived from holonomy compression at a synchronization cost that scales as O(1) relative to accumulated experience by virtue of the non-invertible compression applied at each cache promotion stage, so that the marginal synchronization cost does not grow with the total volume of accumulated thought content. Privacy-preserving exchange 1263 applies multi-stage anonymization to thought patterns selected for cross-instance sharing, progressively removing personally identifiable information from the patterns while preserving geometric structure including trajectory class, holonomy signature, and homotopy membership, and completing anonymization through non-invertible projection into a residual sector from which original thought content cannot be reconstructed, thereby ensuring that structural constraint information is shareable across federated instances without exposing source-domain cognitive content.

An integrated regime-suppression feedback loop 1270 collects outputs from variational stabilization engine 1240, hallucination suppression validator 1250, and resource adaptation manager 1260 and implements bidirectional coupling between the regime monitoring layer and the hallucination suppression layer of adaptive cognitive monitoring system 1200. The forward path of integrated regime-suppression feedback loop 1270 transmits regime transition events from the regime classification stage directly to hallucination suppression validator 1250, enabling regime transitions to modulate the strictness of hallucination suppression thresholds and the sensitivity of the three geometric validation checks in proportion to current saturation state: as the cognitive saturation ratio increases and the system transitions to higher regimes, traversal cost thresholds in traversal cost validation 1251 are tightened, homotopy class admissibility requirements in homotopy class validation 1252 are restricted to more narrowly established classes, and holonomy consistency tolerance in holonomy consistency validation 1253 is reduced, collectively increasing the stringency of hallucination suppression in geometric proportion to the degree of substrate stress. The reverse path of integrated regime-suppression feedback loop 1270 transmits suppression event counts and validation failure patterns from hallucination suppression validator 1250 back to cognitive saturation ratio calculator 1210 as auxiliary inputs that supplement the primary mismatch intensity and adaptive capacity observables, ensuring that elevated suppression rates contribute to upward regime pressure and that sustained reduction in suppression rates contributes to downward regime pressure, thereby closing the adaptive loop between geometric substrate state and behavioral output control.

A response output conditioning module 1280 receives admit and suppress or qualify signals from hallucination suppression validator 1250 and regime state signals from adaptive response controller 1230, and conditions the character of the response output accordingly across four output modes. A full response is produced when the candidate trajectory passes all three geometric validation checks and the current regime state is Regime I or Regime II. A qualified response is produced when the candidate trajectory passes validation but the current regime state is Regime III, accompanying the response content with structured epistemic qualifications reflecting the elevated saturation state of the substrate. A deferred response is produced when the candidate trajectory fails one or more validation checks in a manner consistent with a recoverable geometric condition, such as a homotopy class validation failure indicating structural novelty rather than confirmed inadmissibility, deferring the response pending geometric relaxation or background reorganization that may resolve the trajectory into an established class. A suppressed response is produced when the candidate trajectory fails one or more validation checks in a manner indicating structural inadmissibility, with the failure pattern recorded as a constraint event for accumulation in the suppression history of variational stabilization engine 1240. A substrate evolution feedback module 1290 collects geometric update events from variational stabilization engine 1240, resource adaptation manager 1260, and integrated regime-suppression feedback loop 1270, and distributes updated curvature fields, revised barrier edge sets, and holonomy compression events back to persistent cognitive substrate 1201 through a dashed feedback path, closing the adaptive loop of adaptive cognitive monitoring system 1200 and ensuring that regime-driven behavioral adjustments are reflected in the evolving geometry of the substrate on which future monitoring and suppression operations are based.

### Exemplary Computing Environment

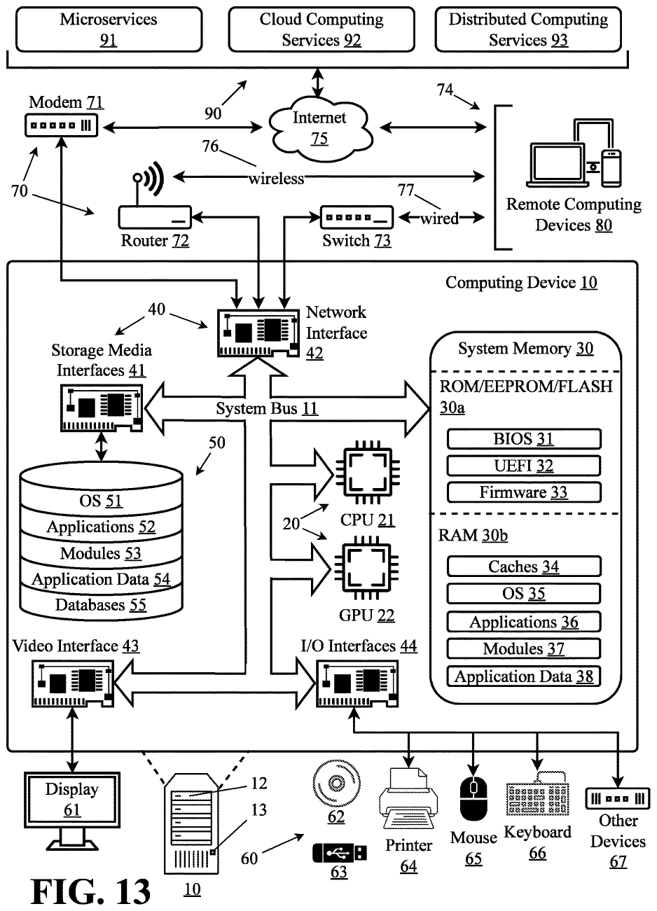

FIG. 13 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computer system comprising a hardware memory, wherein the computer system is configured to execute software instructions stored on nontransitory machine-readable storage media that implement a persistent cognitive substrate organized as an internal configuration space supporting path-dependent traversal, wherein the system:
receives a prompt from a user; projects the prompt into the persistent cognitive substrate through an operational projection that maps input into the internal configuration space where cognitive compatibility corresponds to geometric proximity;
processes the prompt into a plurality of corresponding thoughts using a first reasoning large language model, wherein each thought corresponds to a structured region within the persistent cognitive substrate;
routes both the prompt and the plurality of thoughts through a second large language model that has fewer parameters than the first reasoning large language model;
associates each corresponding thought in the plurality of corresponding thoughts to a portion of the prompt through geometric correspondence within the persistent cognitive substrate;
caches each associated corresponding thought in a federated multi-tier thought caching hierarchy operating as a holonomy-based constraint memory, the hierarchy comprising at least a local device cache, a domain-specific branch instance cache, and a global collective cache, wherein repeated or compatible thoughts are compressed into shared geometric structure such that representational complexity grows sublinearly with accumulated experience;
generates a response to the prompt by processing the plurality of thoughts and the prompt through the second large language model;
continues autonomous reasoning operations without user interaction in a cloud environment, generating new thoughts based on existing cached thoughts and user interaction history through background reorganization of the persistent cognitive substrate; and
coordinates federated cognitive operations across multiple domain-specialized instances through a federated cognitive orchestrator implementing sectorized interface management, wherein domain boundaries correspond to regions of the persistent cognitive substrate where operational projections are non-commuting, and wherein the orchestrator manages thought routing, state synchronization, and cross-domain knowledge sharing while maintaining domain boundaries through graduated access controls.

2. The computer system of claim 1, wherein the system implements variational stabilization of reasoning trajectories, wherein an action functional over trajectory space within the persistent cognitive substrate is deformed by experience such that successful reasoning patterns are reinforced through reduced traversal cost and unsuccessful reasoning patterns are suppressed through increased curvature resistance.

3. The computer system of claim 1, wherein the system implements non-invertible residual export, wherein irreconcilable semantic conflicts arising from cross-domain reasoning operations are projected into a residual sector of the persistent cognitive substrate from which they cannot be reconstructed, ensuring monotonic constraint accumulation and preventing oscillatory reasoning failures.

4. The computer system of claim 1, wherein promoting a thought from a lower tier to a higher tier of the federated multi-tier thought caching hierarchy comprises non-invertible compression of the thought through successive stages of holonomy compression, wherein path-specific details are compressed into transport equivalence classes at each stage and information specific to the originating scope is irreversibly removed.

5. The computer system of claim 1, wherein the system implements multi-domain conflict arbitration comprising:
detecting divergent response trajectories across multiple domain-specialized instances by evaluating geometric distance between response trajectories within the persistent cognitive substrate;
evaluating structural support for each conflicting response based on domain-specific curvature, holonomy weight, and homotopy stability; determining whether a geometric consensus trajectory exists that is reachable from each conflicting trajectory through admissible deformation; and
exporting resolved conflicts into a residual sector through non-invertible projection.

6. The computer system of claim 1, wherein the system implements cognitive regime monitoring based on a cognitive saturation ratio measuring the relationship between mismatch intensity and adaptive capacity, and wherein the system adaptively adjusts processing depth, model selection, and resource allocation in response to transitions between cognitive regimes.

7. The computer system of claim 6, wherein the cognitive regime monitoring detects at least four operational regimes: a weak saturation regime with cache-dominated processing, a selective saturation regime with narrowed trajectory admissibility, a localized saturation regime with explicit uncertainty signaling and deferred judgment, and a distributed near-saturation regime with activated background reorganization.

8. The computer system of claim 1, wherein the system implements hallucination suppression through geometric structural validation comprising:
traversal cost validation that flags response trajectories requiring traversal through high-cost regions of the persistent cognitive substrate;
homotopy class validation that flags response trajectories not belonging to established homotopy classes; and
holonomy consistency validation that flags response trajectories whose loop holonomy is inconsistent with accumulated holonomy in relevant cache tiers.

9. The computer system of claim 1, wherein the system implements battery-aware geometric processing that dynamically adjusts depth and scope of persistent cognitive substrate operations based on device power state, including multiple execution profiles ranging from full-depth traversal with background reorganization to local-cache-only operation with essential state preservation.

10. The computer system of claim 1, wherein the system implements bandwidth-adaptive federated synchronization that adjusts granularity and frequency of structural exchange between federated instances based on available network bandwidth, wherein the system exchanges compressed geometric structure at a synchronization cost that scales as O(1) relative to accumulated experience.

11. The computer system of claim 1, wherein the system implements privacy-preserving structural exchange comprising: multi-stage anonymization of thought patterns through progressive removal of personally identifiable information while preserving geometric structure including trajectory class, holonomy signature, and homotopy membership; and contrastive validation ensuring anonymized patterns retain cognitive utility while preventing re-identification through completed non-invertible projection into a residual sector.

12. The computer system of claim 1, wherein the persistent cognitive substrate implements background reorganization during periods of user inactivity coordinated by a hierarchical sleep management system, the background reorganization comprising perturbation and recombination of existing substrate structure, merging of compatible structures into higher-level abstractions through holonomy compression, and pruning of unused structure through residual export.

13. The computer system of claim 1, wherein the persistent cognitive substrate implements a lifecycle of cognition comprising:
encounter and projection of input into the substrate;
traversal and use along paths shaped by prior learning;
constraint accumulation manifesting as geometric strain at domain boundaries;
consolidation through reuse that compresses and stabilizes substrate regions; and
background reorganization that smooths irregularities and merges compatible structures.

14. The computer system of claim 1, wherein the system implements scaling without resource explosion across memory, computation, and coordination dimensions, wherein effective memory grows sublinearly with accumulated experience through holonomy-based compression, marginal computational cost decreases over time through variational stabilization of frequently used reasoning trajectories, and coordination cost is absorbed into persistent cognitive substrate structure rather than expressed as inter-agent communication.

15. The computer system of claim 1, wherein the federated cognitive orchestrator evaluates a mismatch functional at sector boundaries quantifying the degree of incompatibility between domain representations, and wherein the orchestrator routes cross-domain knowledge transfers through the cross-domain integration framework when mismatch is below an absorption threshold and exports excess mismatch into a residual sector when mismatch exceeds the absorption threshold.
